(19) United States
(12) Patent Application Publication
(10) Pub. No.: US 2006/0020608 A1
(43) Pub. Date: Jan. 26, 2006

(54) Cube update tool

(75) Inventors: Thierry D'Hers, Redmond, WA (US); Aleksandar Juric, Redmond, WA (US); Robert B. Zare, Issaquah, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/054,803

(22) Filed: Feb. 10, 2005

Related U.S. Application Data
(60) Provisional application No. 60/586,644, filed on Jul. 9, 2004.

(51) Int. Cl. G06F 7/00; G06F 17/00

(52) U.S. Cl. 707/100

(57) ABSTRACT

A system that facilitates semi-automatically producing an output relating to a multi-dimensional data object comprises an interface component that receives responses to one or more questions and produces commands that are a function of the responses. An execution engine executes the commands and manipulates the multi-dimensional data object in accordance with the responses. For example, the multi-dimensional object can relate to one or more of a data cube, a dimension, a data source, an attribute, a property, and a mining model.

### REFERENCE TO RELATED APPLICATIONS

This application claims the benefit of U.S. Provisional Application Ser. No. 60/586,644 filed on Jul. 9, 2004, and entitled SYSTEMS AND METHODS THAT FACILITATE SOLVING BUSINESS PROBLEMS, and is related to U.S. patent application Ser. No. ______, filed on Feb. 9, 2005. The entireties of these applications are incorporated herein by reference. This application is also related to U.S. patent application Ser. No. ______, filed on ______.

### TECHNICAL FIELD

The subject invention relates generally to multi-dimensional data, and more particularly to automatically updating/structuring multi-dimensional data to facilitate solving business-related problems.

### BACKGROUND OF THE INVENTION

The evolution of computers with respect to memory storage expansion and processing capabilities has enabled massive amounts of data to be accumulated and analyzed by complex and intelligent algorithms. For instance, given an accumulation of data, algorithms can analyze such data and locate patterns therein. These patterns can then be extrapolated from the data, persisted as content of a data mining model or models, and applied within a desired context. With the evolution of computers from simple number-crunching machines to sophisticated devices, services can be provided that range from video/music presentment and customization to data trending and analysis.

Accordingly, tasks that at one time required skilled mathematicians to perform complex operations by hand can now be automated through utilization of computers. In a simplistic example, many individuals, rather then utilizing a skilled accountant to compute their tax liability, simply enter a series of numbers into a computer application and are provided customized tax forms from such application. Furthermore, in a web-related application, the tax forms can be automatically delivered to a government processing service. Thus, by way of utilizing designed algorithms, data can be manipulated to produce a desired result.

As complexity between relationships in data increases, however, it becomes increasingly difficult to generate an output as desired by a user. For instance, multiple relationships can exist between data, and there can be a significant number of manners by which to review and analyze such data. To obtain a desired output from the data, one must have substantial knowledge of content and structure of such data and thereafter generate a complex query to receive this data in a desired manner. Furthermore, if the data must be manipulated to obtain a desirable output, the user must have an ability to generate algorithms necessary to make the required manipulations or outsource the task to a skilled professional. Thus, typically expert computer programmers and/or data analysis experts are needed to properly query a database and apply algorithms to results of these queries. Moreover, if data or relationships therebetween are significantly altered, the expert programmers and/or data analysis experts may have to return and reconfigure a database query and algorithms to manipulate data returned therefrom. Furthermore, if a user or entity desires a disparate output (e.g., desires to modify data analyzed and/or modify data output), then the expert must be summoned yet again to make necessary modifications. Due to complexity and number of relationships between data, these tasks can require a substantial amount of time, even with respect to one of utmost skill. Accordingly, cost, both in monetary terms and in terms of time, can become significant to a user and/or entity, particularly in a business setting, where data must be analyzed and manipulated to create a desired output.

Accordingly, there exists a need in the art for a system and/or methodology that can aid a user and/or entity in generating a desired output from a mutli-dimensional data structure without assistance from an expert.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention relates to novel systems and/or methods that enable a user that is not an expert in database manipulation to semi-automatically update a multi-dimensional object within a database to generate a desirable output. This is accomplished by way of providing the user with questions/selectable actions that enable the user to logically navigate through alterations that are to be undertaken with respect to the multi-dimensional object. In accordance with one aspect of the subject invention, updates can occur with respect to a data cube, a dimension related to one or more data cubes, attributes relating to a dimension, properties relating to an attribute, dimension, column, or any other suitable entity that can be associated with a multi-dimensional object (e.g., not simply a relational object).

The questions/selectable actions provided to the user can be obtained from a list of acceptable questions/selectable actions that are supported by underlying code. For instance, upon the user selecting a plurality of actions and/or responding to a series of questions, statements and/or commands can be generated that facilitate updating a multi-dimensional object to enable generation of a desired output. An execution engine receives these statements and/or commands and executes such statements/commands against the multi-dimensional object, causing such object to be manipulated as a function of the user's responses/selections to the presented questions/selectable actions. In accordance with an aspect of the subject invention, the questions/selectable actions can be presented to the user as a function of the user's current perspective of the multi-dimensional object. As an example, if the user is navigating through data relating to currency conversion, then the subject invention can provide the user with questions/selectable actions that assist such user in generating a customized currency conversion output (rather than, for example, providing the user with questions relating to sales analysis).

Various aspects of the subject invention can be applied to business-related problems, as such problems are often associated with disparate desired outputs for different customers. For instance, currency conversion may seem like a simple task where a first currency is multiplied by an exchange rate to enable a conversion to a second currency. In actuality, however, such conversion can be complex in view of disparate data types and variables associated with currency conversion. In one example, a bank may receive data relating to several disparate currencies and desirably convert such currencies into other currencies associated with subsidiaries of such bank. Accordingly, complex mapping may be necessarily undertaken to allow these currencies to be converted. Furthermore, different banks can receive data in different formats. For example, with respect to a first bank, a single data packet can indicate that data therein is associated with a particular currency. With respect to a second bank, however, the data packet provides no indication of a currency; rather, a separate data packet associated therewith provides information relating to the currency.

In accordance with another aspect of the subject invention, the questions/selectable answers provided to a user to assist such user in updating a multi-dimensional object and customizing a resultant output are extensible. For instance, over time business needs can alter. A service provider can update the questions/selectable answers to enable more functionality and a wider variety customized outputs for users of one or more aspects of the subject invention.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the subject invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 is a high-level block diagram of a system that facilitates semi-automatically updating a multi-dimensional object in accordance with an aspect of the subject invention.

FIG. 2 is a block diagram of a system that facilitates obtaining information from a user in order to semi-automatically update a multi-dimensional object in accordance with an aspect of the subject invention.

FIG. 3 is a block diagram of a system that facilitates providing a user with questions/selectable actions from a list as a function of user context in accordance with an aspect of the subject invention.

FIG. 4 is a block diagram of a system that facilitates extending a list of questions/selectable actions that can be provided to a user in connection with semi-automatically updating a multi-dimensional object in accordance with an aspect of the subject invention.

FIG. 5 is a block diagram of a system that facilitates semi-automatically updating a multi-dimensional object to produce a customized output in accordance with an aspect of the subject invention.

FIG. 6 is a flow diagram illustrating a methodology for updating a multi-dimensional object to generate a customized output in accordance with an aspect of the subject invention.

FIG. 7 is a flow diagram illustrating a methodology for obtaining sufficient information to appropriately update a multi-dimensional object in accordance with an aspect of the subject invention.

FIG. 8 is a flow diagram illustrating a methodology for saving modifications to a multi-dimensional object to enable re-configuration of the multi-dimensional object in accordance with an aspect of the subject invention.

FIG. 9 is a flow diagram illustrating a methodology for semi-automatically updating a multi-dimensional object in accordance with an aspect of the subject invention.

FIGS. 10-39 are screenshots of exemplary user interfaces that can aid in implementation of one or more aspects of the subject invention.

FIG. 40 is an exemplary computing environment that can be utilized in connection with the subject invention.

FIG. 41 is an exemplary operating environment that can be employed in connection with the subject invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

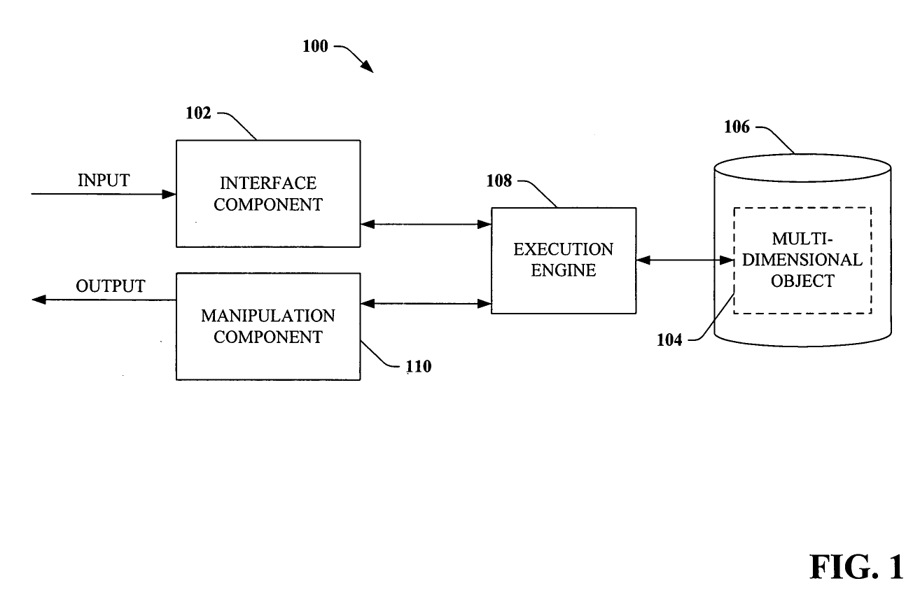

Referring now to the drawings, FIG. 1 illustrates a high-level system overview in connection with one particular aspect of the subject invention. The subject invention relates to a novel system 100 that facilitates updating multi-dimensional objects to solve, for example, common business problems that conventionally require a user to have substantial knowledge of structure and content of the multi-dimensional objects to generate a solution to such problems. It is understood, however, that the system 100 of the subject invention can be employed to automate any suitable updating of one or more multi-dimensional objects to generate a desirable output. The system 100 includes an interface component 102 that receives, for example, input from a user. In accordance with one aspect of the subject invention, the input can be received by way of soliciting a user with one or more questions and/or selectable actions provided to such user by way of a graphical user interface or other suitable presentation device, and thereafter receiving user input in response to such questions and/or actions. For instance, the selectable questions and/or actions can be delivered to the user by way of any suitable video display, audio output, or the like. The questions and/or actions can, for example, relate to currency conversion, sales output with respect to time, accounting, or any other suitable questions and/or actions. The term “questions”, however, when utilized in the claims is intended to refer both to questions provided to a user as well as selectable actions or other selectable data provided to the user.

Upon receipt of the input, the interface component 102 generates commands to update/alter a multi-dimensional object 104 within a data store 106, and an execution engine 108 receives such commands. For example, the selectable questions and/or actions can be associated with templates that are then employed to generate the aforementioned commands. These templates can be associated with commands that are written in a declarative language, such as SQL or MDX, wherein such commands can set properties, create objects, and generate any suitable changes to the multi-dimensional object 104. The execution engine 108, which can reside on a server system with the data store 106, can then cause occurrence of the alterations as specified by the commands. For example, the multi-dimensional object 104 can be a data cube, which enables users to explore and analyze a collection of data from several various perspectives, usually considering three or more dimensions of the cube (or dimensions relating to the cube) at a single instance of time. Data cubes are multidimensional extensions of relational two-dimensional tables, and can be associated with numerous dimensions (e.g., well over three dimensions). Cubes are extremely useful as they can be indexed as a function of any dimension within the cube. Therefore, the commands can relate to appropriate indexing of a data cube (e.g., in accordance with multiple dimensions), processing of a data cube, and the like. It is understood, however, that the multi-dimensional object can be a dimension that is not owned by a particular data cube, a cell of the dimension, or any other suitable data that relates to the multi-dimensional object 104 (e.g., a data cube).

Upon rendering the appropriate updates as a function of the commands (which themselves are a function of the user input to the interface component 102), a manipulation component 110 can receive the updated multi-dimensional object 104 by way of the execution engine 108. For instance, the commands executed by the execution engine 108 upon the multi-dimensional object 104 can be queries that extract certain data indexed in a particular manner, and the execution engine 108 can cause such extraction. The extracted data can then be delivered to the manipulation component 110 that can use an algorithm or series of algorithms to manipulate the data in accordance with the input received by the interface component 102. Furthermore, the manipulation component 110 can cause alterations in data, properties associated with data, or the like and then store such changes in the data store 106 in connection with the multi-dimensional object 104. In accordance with another aspect of the subject invention, the execution engine 108 can cause updating of the multi-dimensional object 104 and storage of such updates upon the data store 106. Thereafter, the manipulation component 110 can access the multi-dimensional object 104 directly (without utilizing the execution engine 108 as an intermediary). Thus, any suitable obtainment of the updated/altered multi-dimensional object 104 is contemplated by the inventors of the subject invention and intended to fall under the scope of the hereto-appended claims.

To provide context with respect to the system 100 (as well as systems/methodologies described infra), one exemplary utilization of the system 100 is provided herein. A user can implement the system 100 by requesting that an operation be performed upon the multi-dimensional object 104 (e.g., by initiating an application that facilitates updating the multi-dimensional object 104). The interface component 102 can provide a user with a list of questions and/or selectable actions, wherein the user employs input devices such as a keyboard, mouse, microphone, and the like to answer one or more of the questions and/or select one or more of the actions. This input is received by the interface component 102, and other more granular questions and/or selectable actions can be presented to the user. The process of soliciting and receiving increasingly granular input can be continued until the interface component 102 has obtained sufficient information to determine a user's desired output or until the user cancels the process. For instance, the interface component 102 can provide a user with questions relating to currency conversion, where type of conversion and rules relating thereto can be gleaned from user responses to questions and/or selected actions.

The interface component 102 can generate commands in accordance with user responses and/or selected actions and the execution engine 108 can receive these generated commands. Thereafter, the execution engine 108 can update/alter the multi-dimensional object 104 and/or extract data in a manner that accords with the received commands. The updated multi-dimensional object 104 and/or data relating thereto can then be received by the manipulation component 110, and such component 110 can apply algorithms that comport with the responses and/or selected actions input by the user in response to provided questions and/or selectable actions. Thus, for instance, the manipulation component 110 can manipulate extracted (updated) data from the multi-dimensional object 104 and/or the entirety of the multi-dimensional object 104 can be modified to create an output that is desirable to the user (e.g., as a function of the responses and/or the selected actions). Therefore, in accordance with the previously mentioned currency conversion example, the user can generate a customized output with respect to currency conversion without requiring intricate detail with respect to structure and content of the multi-dimensional object 104 and/or expert programming skills.

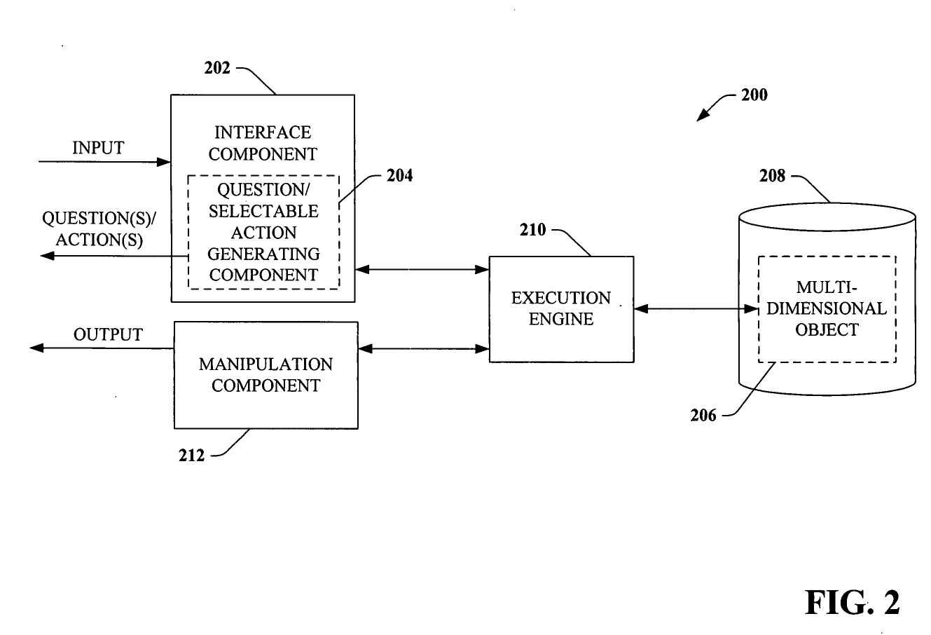

Turning now to FIG. 2, a system 200 that facilitates enabling a user that is not an expert computer programmer to update a multi-dimensional object or data associated therewith to cause generation of a desired output is illustrated. The system 200 includes an interface component 202 that receives input from a user or other suitable entity. The interface component 202 includes a question/selectable action generating component 204 that solicits the input by presenting one or more questions that can be answered by the user/entity and/or one or more selectable actions that can be selected by the user/entity. Upon receiving the input, the interface component 202 can communicate with the question/selectable action generating component 204 to determine if further questions/selectable actions should be provided to the user/entity. For instance, questions/selectable actions can be linked together, so that the selection of one causes presentment of disparate, possibly more granular questions/selectable actions. Therefore, a substantial amount of information can be obtained from a user by way of the question/selectable action generating component 204, wherein such information enables the system 200 to modify a multi-dimensional object 206 within a data store 208 according to a user's desired output.

Upon receiving sufficient information (e.g., a lineage of questions/selectable actions has been traversed), the interface component 202 generates commands as a function of the received input, wherein the commands can be utilized to manipulate the multi-dimensional object 206 and/or extract information from the multi-dimensional object 206. The commands are received by an execution engine 210, and the execution engine 210 can notify the interface component 202 of receipt of such commands. Such an implementation of the system 200 can be beneficial if the execution engine 210 and the interface component 202 reside on disparate machines (e.g., the execution engine 210 is on a server while the interface component 202 is on a client). The execution engine 210 can then execute the commands against the multi-dimensional object 206 to modify such object 206 and/or extract data therefrom. For instance, properties relating to the multi-dimensional object 206 can be altered to modify an indexing thereof, dimensional indexing can be modified, objects relating to the multi-dimensional object 206 an be created, and the like.

A manipulation component 212 can access the modified/updated multi-dimensional object 206 and apply algorithms thereto to generate an output that accords with the input received by the interface component 202. Furthermore, the manipulation component 212 can directly access the multi-dimensional object 206 if a circumstance so calls, rather than accessing the multi-dimensional object 206 by way of the execution engine 210. The manipulation component 212 can thus update and/or modify the multi-dimensional object 206 by applying algorithms that correspond to the input received by the interface component 202 and solicited by the question/selectable action generating component 204. For example, if a user wished to output a currency conversion with certain rules, the manipulation component 212 can effectuate such rules upon the multi-dimensional object 206 being indexed in a desirable manner. Thus, the manipulation component 212 can provide a customized output as a function of the user input.

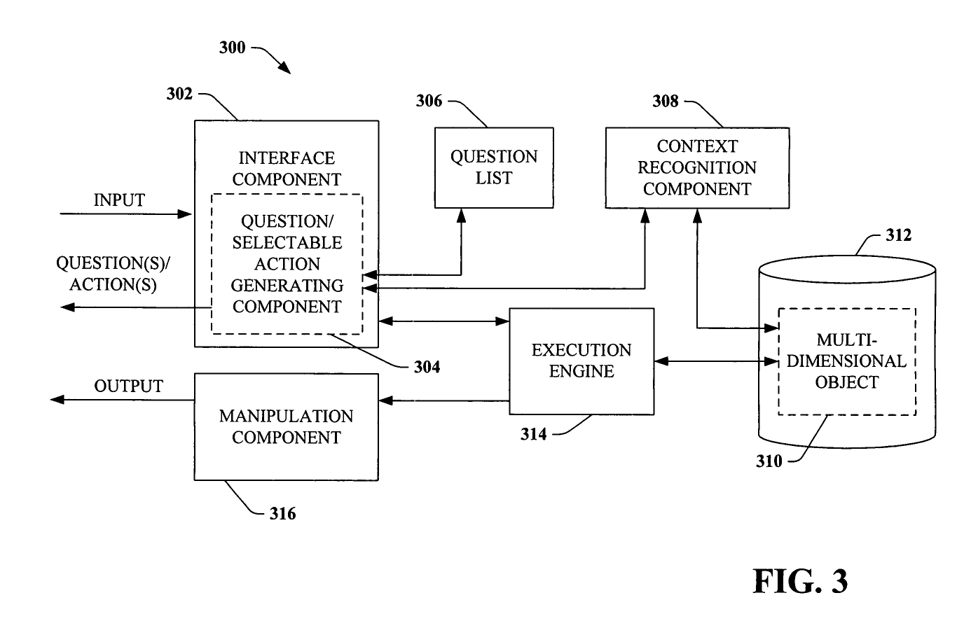

Now referring to FIG. 3, a system 300 that facilitates providing a customized output with respect to a complicated problem by way of updating a multi-dimensional object is illustrated. The system 300 includes an interface component 302 that receives input from a user by way of the user's response to one or more questions/actions. The questions/actions are presented to the user by way of a question/selectable action generating component 304, wherein the questions/actions can be presented to a user in any suitable manner. The questions/actions are selected by the question/selectable action generating component 304 from a question list 306 that includes questions/actions supported by the system 300. For example, the system 300 can support a vast majority of outputs relating to currency conversion that an individual or business entity might desire, and thus the question list 306 includes questions/actions that can be utilized to obtain requisite information from a user to enable a desired currency conversion.

A context recognition component 308 can assist the question/selectable action generating component 304 in determining which questions/actions from the question list 306 to initially present to the user. For example, the context recognition component 308 can determine a user perspective/context with respect to a multi-dimensional object 310 within a data store 312. For example, if a user is currently viewing the multi-dimensional object with respect to accounting numbers when initiating the interface component 302, the context recognition component 308 will recognize the current view and inform the question/selectable action generating component 304 to provide questions/selectable actions to the user that relate to accounting (and not, for example, currency conversion or time-related sales analysis). Thus, the user will be provided with a list of questions/selectable actions relevant to an output desired by the user, and such user will not be presented with superfluous and undesirable questions/selectable actions. Accordingly, the user will not be confused and/or frustrated with a substantial amount of irrelevant information.

Upon determining an initial question or list of questions and/or action or list of actions, the interface component 302 can present such initial list to a user. The user can respond to a desired question and/or select a desired action, and thereafter (if necessary) the question/selectable action generating component 304 can present additional questions/actions to the user from the question list 306. The context recognition component 308 may not be necessary at this point, as the initial questions/actions can be associated with a chain of related questions/actions to present to the user. The interface component 302, after receiving sufficient information as a function of the questions/selectable actions, can generate commands to update the multi-dimensional object 310 to enable production of an output as desired by the user of the system 300. The commands can be received by an execution engine 314 that executes the commands against the multi-dimensional object 310 and updates such object 310 as a function of the responses to the questions/selected actions. A manipulation component 316 then manipulates the updated multi-dimensional object 310 to produce an output that is desired by a user of the system 300. For instance, a customized view of sales data with respect to time can be output by the manipulation component 316 and presented to the user of the system 300.

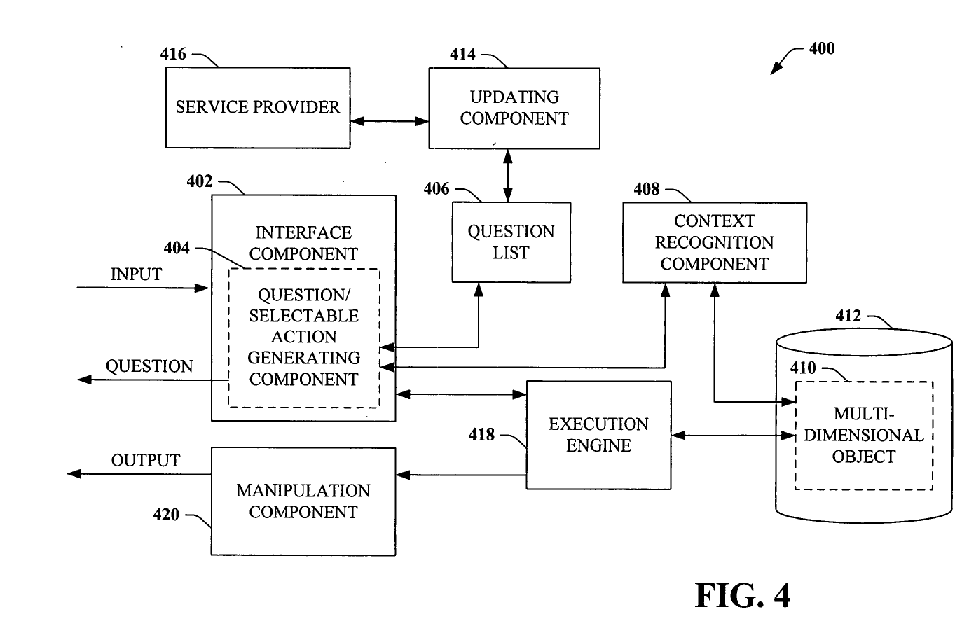

Turning now to FIG. 4, a system 400 that facilitates producing an output associated with a multi-dimensional object in a semi-automated manner is illustrated. The system 400 includes an interface component 402 that receives input from a user and generates commands to alter a data cube as a function of such input. The input is solicited from the user by way of a question/selective action generating component 404, which provides the user with one or more questions and/or one or more selectable actions. Such questions/actions are obtained from an extensible question list 406 and can include any suitable number and type of questions/selectable actions. At least an initial grouping of questions/actions are provided to the user with aid from a context recognition component 408, which determines a current user perspective of a multidimensional object 410 that is desirably updated to enable generation of an appropriate output. An initial collection of questions/actions is obtained from the question list 406 as a function of the determined perspective (e.g., if the user is viewing a currency dimension related to the multi-dimensional object 410, then the interface component 402 should provide the user with questions/actions relating to currency conversion). The multi-dimensional object 410 exists within a data store 412 which can, for example, be retained upon a server system.

As the system 400 obtains input by way of soliciting information through a series of questions and/or selectable actions, the system 400 is desirably extensible given changing user/business needs. Accordingly, the system 400 includes an updating component 414 that receives updated questions, selectable actions, and underlying code to effectuate updating the multi-dimensional object 410 from a service provider 416. For instance, the service provider 416 can be communicatively coupled to the updating component 414 and inform the updating component 414 of questions, actions, and/or code that is available for utilization with the system 400. The updating component 414 can then update the question list 406 with additional questions/selectable actions supported by the system 400. In accordance with one aspect of the subject invention, users can be made aware of new/additional functionality of the system 400 and thereafter be provided with an opportunity to purchase such functionality. Any suitable updating system and/or method, however, is contemplated and intended to fall under the scope of the hereto-appended claims.

Upon receiving requisite input from the user (through responses to questions/selectable actions), the interface component 402 generates commands to update the multi-dimensional object 410. An execution engine 418 receives these commands and executes such commands against the multi-dimensional object 410. Thus, properties can be set, objects can be created, and the like to enable generation of a desired output. Moreover, the commands generated by the interface component 402 can be utilized as a query to extract desired information from the multi-dimensional object 410. This information can then be passed to a manipulation component 420 that utilizes algorithms to alter the received data and generate an output in accordance with the user responses. In accordance with another aspect of the subject invention, the execution engine 418, rather than simply retrieving information, can itself modify the multi-dimensional object 410 and store such modifications within the data store 412. Thereafter, the manipulation component 420, if necessary, can make further modifications to the multi-dimensional object (or data related thereto) and output such modification (if any) to the user.

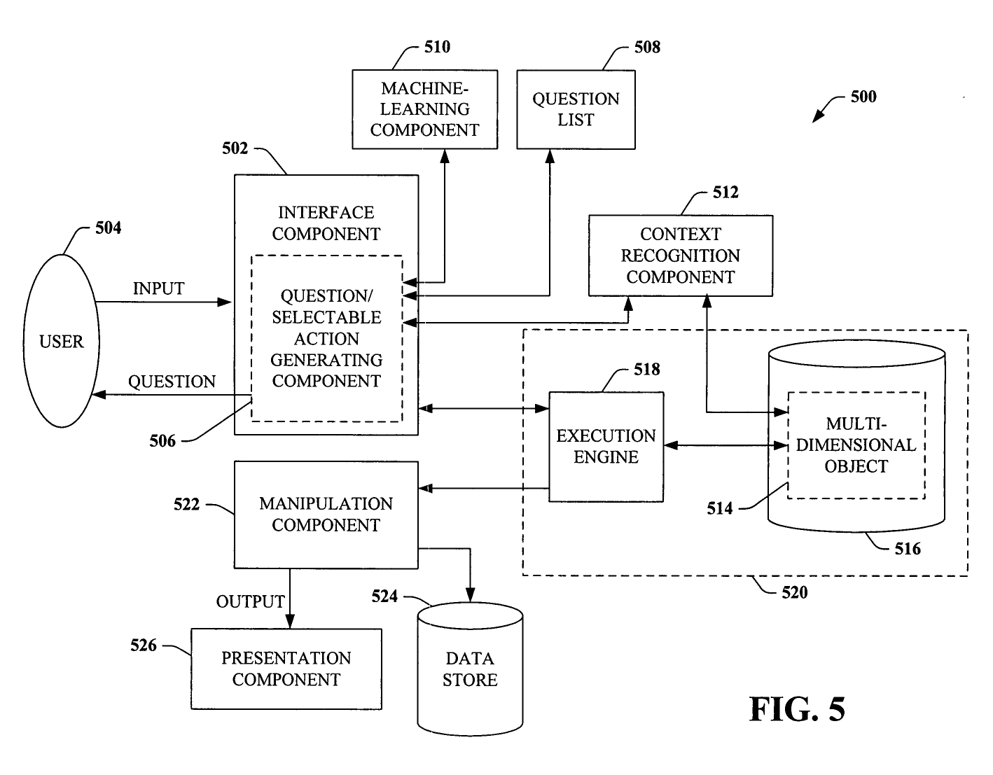

Referring now to FIG. 5, a system 500 that facilitates updating a multi-dimensional object and generating an output that is based at least in part upon the updated object is illustrated. The system 500 includes an interface component 502 that receives input from a user 504, wherein such input is solicited by way of a question/selectable action generating component 506. For instance, the question/selectable action generating component 506 can initially provide the user 504 with one or more questions/selectable actions, and upon receiving a response from the user 504 provide disparate, more granular associated questions and/or selectable actions.

With respect to the selection of initial questions/actions provided to the user 504, such selection can be provided by way of a question list 508 and aided through utilization of a machine-learning component 510 and a context recognition component 512. For instance, the context recognition component 512 can analyze the user's perspective of a multi-dimensional object (or data therein) and one or more questions from the question list 508 can be provided to the user 504 as a function of such analysis. The machine-learning component 510 can further assist in providing most-pertinent questions/selectable actions to a user. For instance, the machine learning component 510 can watch utilization of the system 500 over time and generate inferences with respect to questions/selectable actions that are to be provided to the user 504.

As used herein, the terms to “infer” or “inference” refer generally to the process of reasoning about or inferring states of a system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Thus, the question/selectable action generating component 506, with aid from the machine-learning component 510, can provide the user 504 with only pertinent questions/actions. In one example, the machine-learning component 510 can monitor the interface component 502 over time and notice patterns of action of the user 504 and/or other users that relate to such user (e.g., users in a substantially similar department of a business). Furthermore, the machine-learning component 510 can delete questions/selectable actions from the question list 508 if the user 504 has, in the recent past, selected such questions/actions (e.g., because it can be inferred that the user 504 will not want to repeat what's previously been done).

Moreover, sequence of questions/selectable actions can be provided to the user 504 with aid from the machine-learning component 510. For instance, the user 504 can, historically, traverse through dimensions of a data cube in a particular order when preparing to undertake a certain task or desiring to generate a specific output. The machine-learning component 510 can watch the user 504 and learn tendencies given disparate user contexts, and inform the question/selectable action generating component 506 to provide the user with a mot pertinent set and/or sequence of questions/actions. In another example, the user 504 can historically first request a currency conversion to be output from the system 500 followed by an analysis of currency converted over particular periods of time. Thus, the machine-learning component 510 can learn these tendencies and inform the question/selectable action generating component 506 to provide the user 504 with particular questions/actions in a certain sequence.

Upon receipt of sufficient information, the interface component 502 generates commands to modify a multi-dimensional object 514 in a manner that enables the system 500 to produce an output in accordance with the received information. In accordance with one aspect of the subject invention, the multi-dimensional object 514 can be a cube, a dimension owned by a cube, data relating to a cube and/or dimension, and the like. Furthermore, the multi-dimensional object 514 can be stored in a data store 516, which can be RAM, ROM, or any other suitable data storage devices and/or formats. An execution engine 518 receives the commands and utilizes such commands to update the multi-dimensional object 514 in accordance with the input provided by the user 504. In accordance with one aspect of the subject invention, the data store 516 that houses the multi-dimensional object 514 and the execution engine 518 can reside together upon a server 520 (or server system).

Upon updating the multi-dimensional object 514 (e.g., adding objects associated therewith, updating properties associated therewith, altering indexing of the multi-dimensional object, . . . ), data necessary to generate a desired output is delivered from the execution engine 518 to a manipulation component 522. The manipulating component 522 can apply algorithms against the data, format the data in a manner suitable for display, and the like. In accordance with another aspect of the subject invention, the manipulation component 522 can package the commands created by the interface component 506, data retrieved by the execution engine 518, and algorithms that acted upon the data to enable the user 504 to complete a substantially similar task at a later time without having to re-input information. This package of data (which can be stored, for example, as an object) can be stored within a data store 524. While the manipulation component 522 is illustrated as storing the packaged data within the data store 524, it is understood that the system 500 can be modified to cause the packaged data to be stored within the data store 516 upon the server 520. After the manipulation component 522 operates on the multi-dimensional object 514 and/or data extracted therefrom by the execution engine 518, it provides a customized output that accords to the responses to the questions/selectable actions to a presentation component 526. The presentation component 526, can be, for example, a graphical user interface (e.g., a computer screen), a printer, speakers, a projector, or any other suitable device that can be utilized to present the output to the user 504. Thus, utilizing the system 500 of the subject invention, the user 504 (not an expert in computer programming) can manipulate the multi-dimensional object 514 and data associated therewith and cause a customized output to be produced.

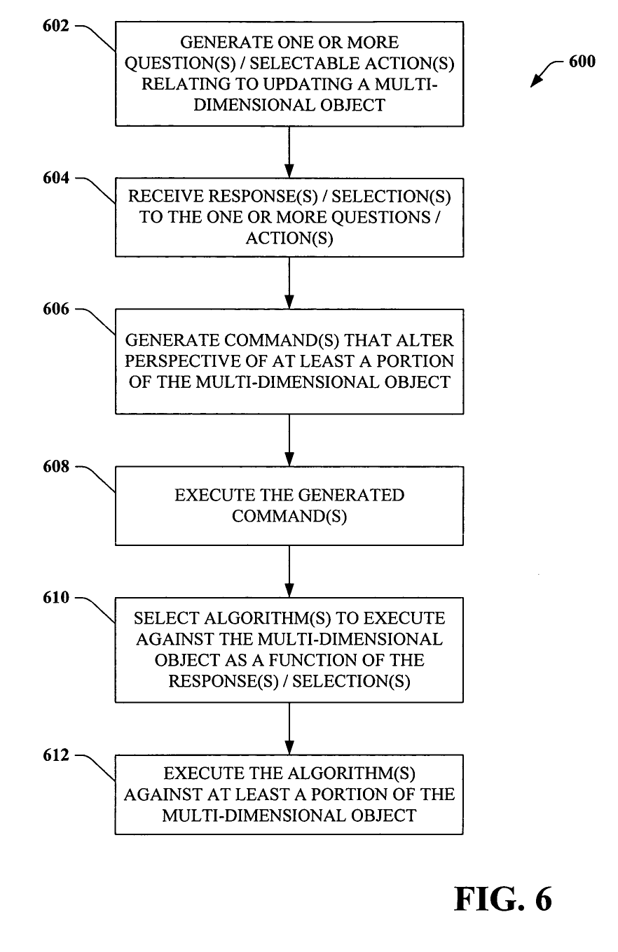

Now referring to FIGS. 6-9 methodologies in accordance with various aspects of the subject invention are illustrated. While, for purposes of simplicity of explanation, the methodologies are shown and described as a series of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

Now turning solely to FIG. 6, a methodology 600 that facilitates updating a multi-dimensional object is illustrated. At 602, one or more questions and/or one or more selectable actions relating to updating a multi-dimensional object are provided. For example, the questions can relate to complex business operations, such as currency conversion, sales analysis with respect to time, accounting, and the like. Furthermore, the questions/selectable actions can be presented to a user by any suitable means, such as a computer display, audibly through one or more speakers, or the like. At 604, responses/selections relating to the generated questions/selectable actions are received. For instance, these responses can be received by way of a pointing and clicking mechanism, keystrokes, microphone and voice recognition systems, pressure-sensitive screens, and/or any other suitable input mechanisms.

At 606, commands that alter a perspective of at least a portion of the multi-dimensional object are generated as a function of the responses/selections. For example, indexing of the multi-dimensional object can be altered. At 608, the commands are executed against the multi-dimensional object, thereby causing the at least portion of the multi-dimensional object to be altered. At 610, algorithms to execute against the altered multi-dimensional object (or a portion thereof) are selected as a function of the responses/selections to the questions/selectable actions. Thus, for instance, if the methodology 600 were utilized to perform a currency conversion, algorithms relating to currency rates could be applied against disparate currencies. At 612, algorithms are executed against at least the portion of the multi-dimensional object, thereby generating an output that is customized according to responses/selections to the provided questions/selectable actions.

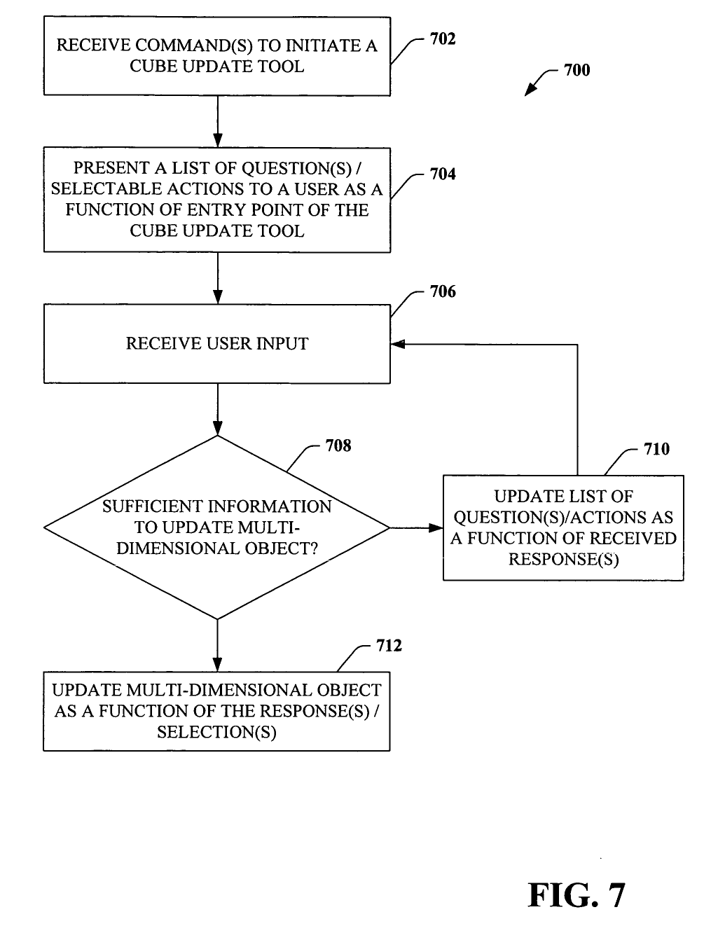

Now turning to FIG. 7, a methodology 700 that facilitates semi-automatic updating of a multi-dimensional object is illustrated. At 702, commands are received to initiate a tool that enables semi-automatic updating of a multi-dimensional object. For instance, the tool can be initiated through selection of a graphical object upon a computer screen, voice commands, a series of keystrokes, pressure applied to a pressure-sensitive screen, and the like. In another example, it may be possible to initiate the cube update tool only if the multi-dimensional object is currently being contemplated by a user. In accordance with such an aspect, operation of the multi-dimensional object update tool can be a function of user context with respect to the multi-dimensional object. At 704, a list of questions/actions is presented to a user as a function of entry point of the multi-dimensional object update tool. For example, if the user initiates the tool while reviewing currency data, then questions/actions provided to the user will relate to currency conversion (and not, for example, sales analysis). If the user's desires are not in accordance with current utilization or view of the multi-dimensional object, then the user can be provided with an option to be provided with a broader range of actions/questions.

At 706, input is received, wherein the input is user responses/selections to the questions/actions provided to such user. For example, the input can be received by way of keystrokes, voice input, or any other suitable input. At 708, a determination is made regarding whether a sufficient amount of information has been obtained to enable the multi-dimensional object to be updated according to the user's wishes. If there is insufficient information, then at 710 the list of questions/actions is updated as a function of the received responses. For instance, the list of questions/actions can be populated with more granular questions/actions than those previously responded to and/or selected. After the list has been updated, the user answers the questions and/or selects one or more actions, thereby enabling the multi-dimensional object update tool to receive additional user input at 706. The list of questions/actions can be updated and user input can be received until sufficient information is obtained to enable updating of the multi-dimensional object. Once sufficient information is received, at 712 the multi-dimensional object is updated as a function of the responses/selected actions. This updating of the multi-dimensional object enables a user to semi-automatically perform complex data arrangements and calculations to generate a desired output. For instance, customized output relating to currency conversion can be generated through utilization of the methodology 700.

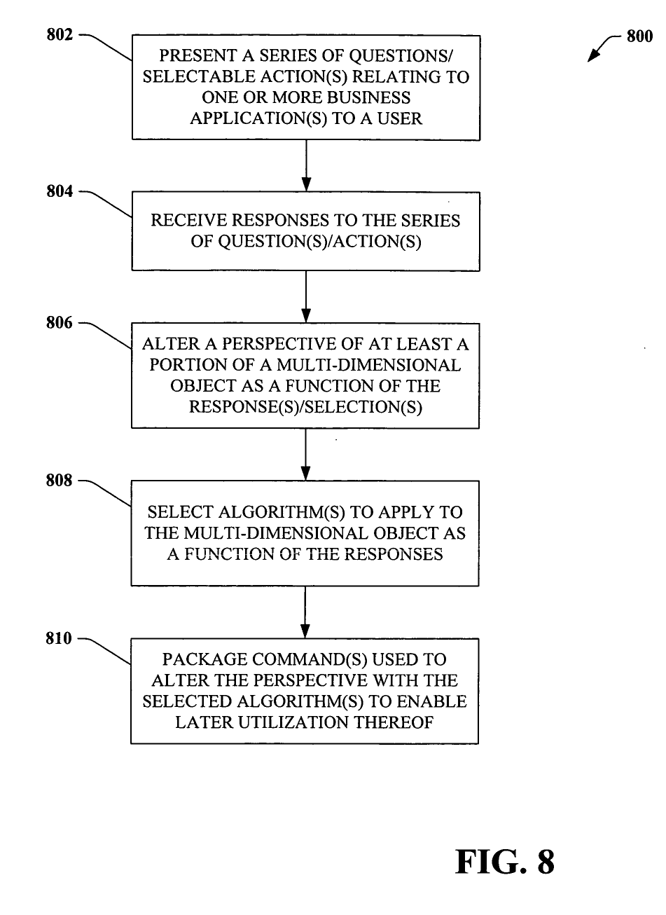

Now Referring to FIG. 8, a methodology 800 that facilitates solving one or more complex business problems by way of manipulating a multi-dimensional object is illustrated. At 802, a series of questions and/or selectable actions relating to one or more business applications is presented to a user. For example, the business applications can relate to currency conversion, sales data analysis with respect to time, accounting analysis, and the like. More particularly, currency conversion may seem like a simple task, where a first currency is multiplied by a rate and thereafter transformed into a second currency. In reality, however, many significantly more complex tasks are typically required to be undertaken. For instance, banks often must have an ability to convert from any first currency to any second currency, thus complicating the currency conversion process. Furthermore, if the bank is a subsidiary of a disparate bank that is in a different country, the bank may wish to convert all currency to that of its parent bank. These possible issues are merely exemplary to illustrate that manipulating a multi-dimensional object to enable desirable output in connection with a common business application can be a complex and burdensome task.

At 804, responses/selections in accordance with the presented questions/actions are received. In particular, the user can make selections and/or answer questions in a manner that enables generation of an output that is customized for a particular business application. At 806, at least a portion of a multi-dimensional object is altered as a function of the selected actions/responses. For instance, a data cube can be indexed according to the selected actions/responses. At 808, algorithms to apply to the altered multi-dimensional object are selected as a function of the responses/selected actions. For example, if currency conversion is desired, the algorithms can be a simple multiplication algorithm that multiplies a current currency by a particular rate. Other more involved and more complex algorithms are contemplated by the inventors and intended to fall under the scope of the hereto-appended claims. At 810, the commands utilized to alter the perspective are packaged with the algorithms employed at 808, thereby enabling a user to later cause a substantially similar output to be re-generated without having to first respond to a plurality of questions and/or select a plurality of actions. For instance, the commands and algorithms can be packaged in the form of a graphical object, which the user can subsequently select to initiate such commands/algorithms.

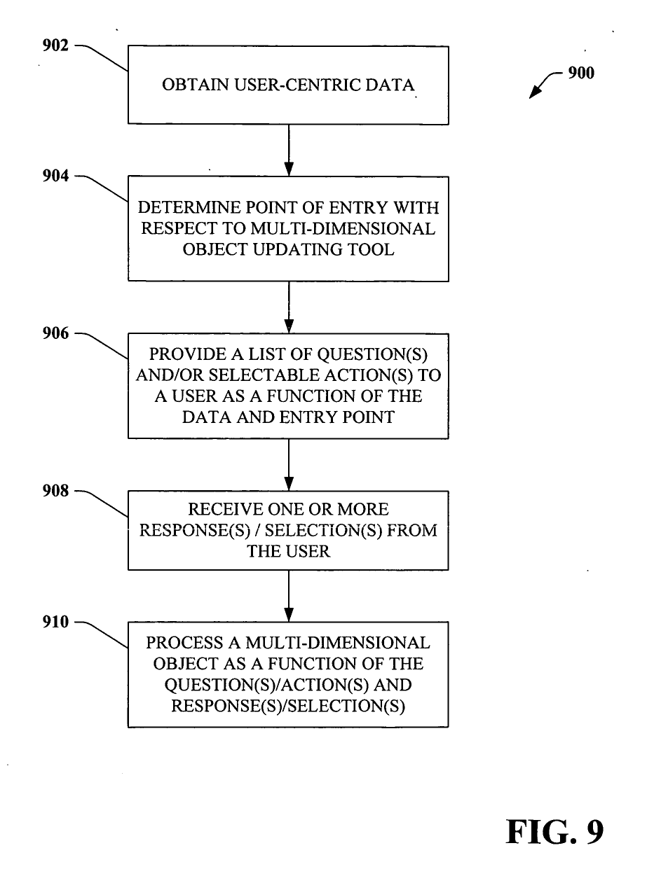

Referring now to FIG. 9, a methodology 900 for updating and processing a multi-dimensional object in connection with producing a customized output is illustrated. At 902, user-centric data is obtained. For instance, a computer or other device can be monitored over time to obtain the user-centric data, such as patterns of use associated with a user, role of a user within a company, and the like. At 904, a point of entry is determined with respect to a multi-dimensional object-updating tool. For instance, current user-perspective with respect to a data cube or the like can be determined upon initialization of the multi-dimensional object-updating tool. At 906, a list of questions and/or selectable actions is provided to a user as a function of the obtained user-centric data and the determined point of entry. Using such information, the user will not be provided with questions/actions that are unrelated to a user's desired task. At 908, one or more responses and/or selections are received from the user. At 910, a multi-dimensional object is processed as a function of the questions/actions and responses thereto. A user can then receive a semi-automated, customized output through manipulation of the multi-dimensional object.

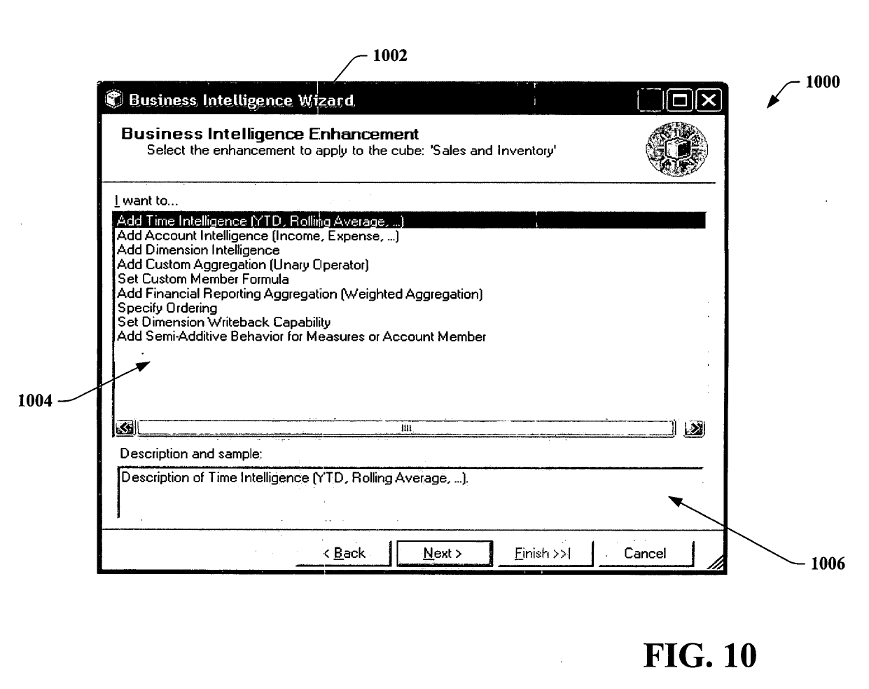

Now briefly referring to FIGS. 10-41 collectively, screen shots and user interfaces relating to exemplary implementations of various aspects of the subject invention are illustrated. In particular, these figures illustrate a multi-dimensional update tool that enables complex business applications to be generated by a user who is not an expert in computer programming and/or database management. Accordingly, the systems supporting these screen shots include algorithms and/or multi-dimensional object manipulation devices that enable customized output relating to these business applications. It is understood, however, that the subject invention can be applied to various other contexts, and that the claims herein are not to be interpreted as limited to the business context.

Referring solely to FIG. 10, a screen shot 1000 of an exemplary user interface 1002 providing a plurality of selectable actions is illustrated. The user interface 1002 includes a field 1004 that comprises a plurality of selectable actions, including an action that enables a user to add time intelligence to a multi-dimensional object (e.g., a cube), add income account intelligence, add dimension intelligence, add custom aggregation, set custom member formula, add financial reporting aggregation, specify ordering, set dimension writeback capability, and add semi-additive behavior for measures or account member. This list is merely exemplary, and not limitative, as such list can be expanded to include various other actions/questions. Furthermore, a field 1006 is available that can provide a description and/or a sample of a selected action.

Moreover, some of the actions illustrated can be associated with various properties and availabilities. For instance, the addition of time intelligence can be available with respect to a cube and a dimension therein as well as be available in connection with a sourceless cube. In another example, account intelligence can be added with respect to a cube and/or dimension of a cube, as well as to a sourceless cube and a sourceless dimension. A table is provided below as to how context in which the listing of actions is available.

| | | Available | Available |
|---|---|---|---|
| | | with | with |
| | Available for | Sourceless | Sourceless |
| Action | Cube/Dimension | Cube | Dimension |
| Add Time | Cube | Yes | NA |
| Intelligence | | | |
| Add Account | Cube and | No | No |
| Intelligence | Dimension | | |
| Add Dimension | Cube and | Yes | Yes |
| Intelligence | Dimension | | |
| Add Custom | Cube and | No | No |
| Aggregation | Dimension | | |
| Set Custom Member | Cube and | No | No |
| Formula | Dimension | | |
| Add Financial | Cube and | No | No |
| Reporting | Dimension | | |
| Aggregation | | | |
| Specify Ordering | Cube and | Yes | Yes |
| | Dimension | | |
| Set Dimension | Cube and | Yes | Yes |
| Writeback | Dimension | | |
| Capability | | | |

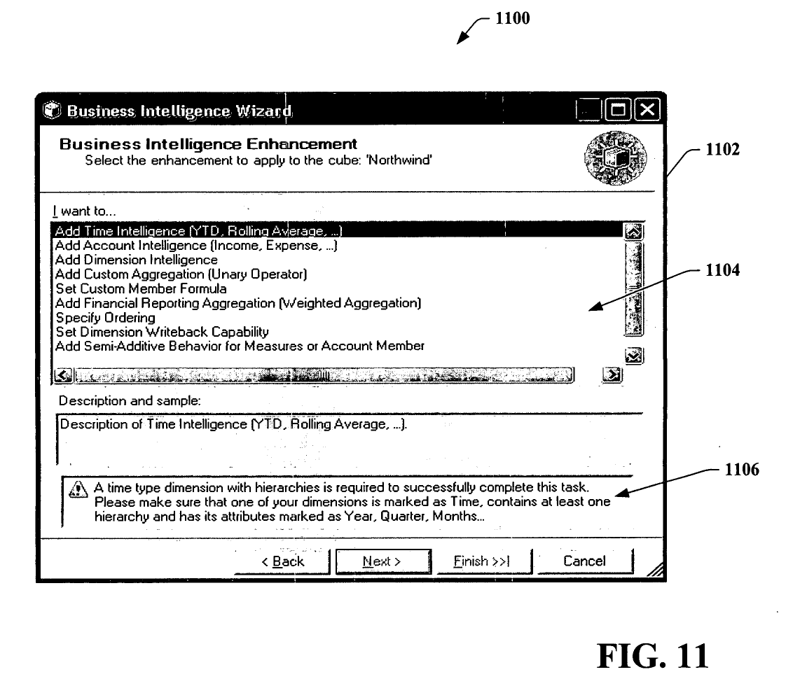

Referring briefly to FIG. 11, a screen shot 1100 of an exemplary user interface 1102 illustrating another exemplary aspect of the subject invention is provided. An action (Add Time Intelligence) has been selected by a user from a selection field 1004. A field 1106 includes text relating to a warning or instructions associated with the selected action. Thus, if insufficient data exists or a multi-dimensional object cannot be appropriately updated, the field 1106 will be updated to inform a user of steps to be taken and/or inform the user of problems associated with the selection.

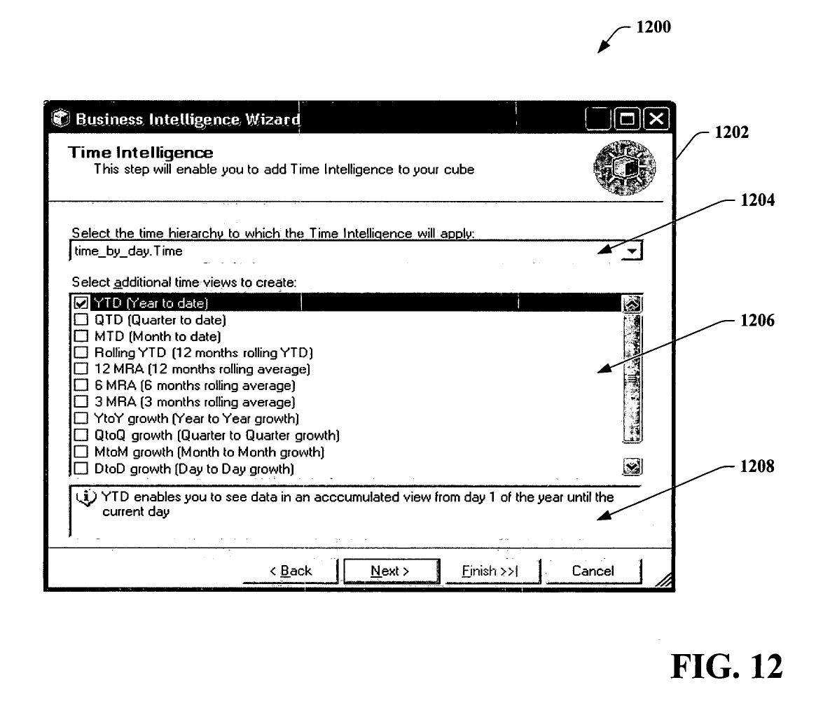

Turning now to FIG. 12, a screenshot 1200 of an exemplary user interface 1202 is illustrated, wherein the user interface 1202 is provided upon a user selecting an “Add time Intelligence” from a list as illustrated in FIG. 11. The user interface 1202 includes a pull-down menu 1204 that allows a user to select a time-hierarchy from a possible list of time hierarchies. Furthermore, the user interface 1202 includes a field 1206 of selectable options from which to view data as well as a field 1208 that describes the selections. Thus, for example, if a user selects a check box 1210 associated with a “Year to Date” time view, then the field 1208 will describe results of this selection (thereby assisting the user in creating a customized output). As an example, if a selection is made as indicated in the screenshot 1200, then a query/algorithm is activated against the selected hierarchy and an appropriate output is created. One exemplary algorithm is as follows:
SUM(YTD(<Selected time hierarchy name>.Currentmember), <New Time Intelligence hierarchy name>. [Current of <Selected Time hierarchy>])
This command enables a user to view data in an accumulated view from the first day of the year until the current day. The other selectable actions include statements/commands/algorithms that enable data to be viewed accordingly. For instance, selecting “Rolling YTD” would enable data to be viewed from a day one year in the past to a current day. Further, multiple calculations can be selected from the field 1206, and a measure can be created and populated within a created or modified time-dimension as a function of such selected calculations.

In accordance with one aspect of the subject invention, measures (not shown) can be selected prior to (or after) a user choosing a desired calculation. For instance, due to constraints associated with a calculation engine, the measures can be divided into two disparate groups: physical measures and calculated measures. An exemplary listing of such divided measures is provided below:

Physical Measures Selected

[Measures].[Amount]
[Measures].[Number of Employees]
[Measures]. [Overtime Hours]
[Measures].[Overtime Salary]
[Measures].[Paycheck Tally]
[Measures]. [Salary]
[Measures]. [Supply Time]
[Measures].[Units Ordered]
[Measures].[Units Shipped]
[Measures].[Warehouse Costs]
[Measures].[Warehouse Sales]
[Measures].[Sales Count]
[Measures].[Store Costs]
[Measures].[Store Sales]
[Measures].[Unit Sales]
   Calculated Measures Selected:
[Measures].[Average Salary]
[Measures].[Employee Salary]
[Measures].[Net Warehouse Sales]
[Measures].[Net Store Sales]
[Measures].[Sales Average]
   Moreover, a target dimension/hierarchy (e.g., Time.Time) can be selected by a user and/or automatically selected by an intelligent component, wherein the hierarchy can be structured by Year, Semester, Quarter, Month, Day, or any other suitable hierarchical structure (e.g., trimester rather than semester). For purposes of examples provided herein, however, the above-described hierarchical structure is employed.

To further the above example, various time-related calculations can be effectuated against selected measures. For instance, year-to-date calculations, six-month moving average calculations, year over year growth calculations, and year over year growth percentage calculations can be chosen from the field 1206 to operate over the selected measures (described above). To initiate the calculations, a member of a multi-dimensional structure (e.g., a data cube) can be created, named, and assigned a null value (so that such value can be modified at a later instance of time). Thereafter, defined calculations can be operated against the selected measures, and the measures created relating to the calculations can be populated.

In accordance with another aspect of the subject invention, the physical measures selected can be placed within a grouping, wherein calculations are limited to such grouping. Due to engine constraints, however, the selected calculated measures may be specified with respect to each calculation involving such measures (although the specification can be done automatically upon selection of the measures). Such separation of physical measures and calculated measures does not affect functionality, but rather only affects code underlying the exemplary user interface 1202. The aforementioned calculation relating to year-to-date calculations, effectuated in MDX against a particular dimension, hierarchy, and member, with respect to selected measures is provided below.

| Scope ( { | [Measures].[Amount], [Measures].[Number of Employees], |
|---|---|
| | [Measures].[Overtime Hours], [Measures].[Overtime Salary], |
| | [Measures].[Paycheck Tally], [Measures].[Salary], |
| | [Measures].[Supply Time], [Measures].[Units Ordered], |
| | [Measures].[Units Shipped], [Measures].[Warehouse Costs], |
| | [Measures].[Warehouse Sales], [Measures].[Sales Count], |
| | [Measures].[Store Costs], [Measures].[Store Sales], |
| | [Measures].[Unit Sales] } ) ; |

```
( [Time].[Time Calculations].[Year to Date],
  [Measures].[Average Salary], [Measures].[Employee Salary],
  [Measures].[Net Warehouse Sales], [Measures].[Net Store Sales],
  [Measures].[Sales Average],
  [Time].[Time].[Year].Members ) =
```

Aggregate(

PeriodsToDate(

[Time].[Time].[Year],
[Time].[Time].CurrentMember
),

[Time].[Time Calculations].DefaultMember
);

The “scope” statement selects all physical measures with respect to which the calculation is to be undertaken upon. Thereafter, a member ([Year to Date]) of a selected hierarchy ([Time Calculations]) of a dimension ([Time]) is written to with respect to the measures in the “scope” statement and selected calculated measures. An aggregation function is then utilized to obtain data from appropriate locations within the multi-dimensional structure to complete a year to date calculation. Results can then be stored in the specified member ([Year to Date]).

Another exemplary calculation (six month moving average) undertaken in MDX with respect to a data cube is provided herein to further illustrate an exemplary embodiment associated with the subject invention with respect to calculating a time dimension. It is understood, however, that this calculation is merely one manner to calculate a time dimension with respect to a defined calculation, and other means of performing and storing such calculation are contemplated.

( [Time].[Time Calculations].[Six Month Moving Average],

[Measures].[Average Salary], [Measures].[Employee Salary],
[Measures].[Net Warehouse Sales], [Measures].[Net Store Sales],
[Measures].[Sales Average],
[Time].[Time].[Month].Members ) =
AVG(

{

ParallelPeriod(

[Time].[Time].[Month],
5,
[Time].[Time].CurrentMember
)

: [Time].[Time].CurrentMember

},

[Time].[Time Calculations].DefaultMember
);

End Scope;
For sake of brevity, additional exemplary calculations are not provided, but a structure of such calculations can be deduced from the above examples and known mathematics underlying such calculations.

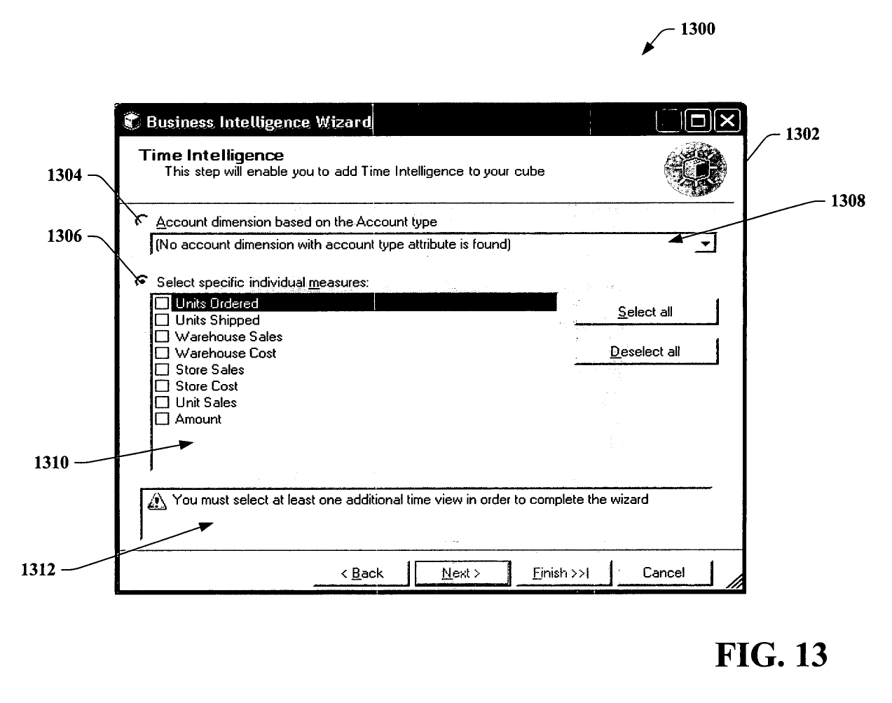

Referring now to FIG. 13, a screenshot 1300 of an exemplary user interface 1302 is provided, wherein the user interface 1302 enables a user to specify data to apply a selected time-related rule against (as shown in FIG. 12). The user interface 1302 can include various radio buttons 1304 and 1306 to assist the user in specifying a manner in which a previously selected time-related rule is to be applied. Thus, the user can select one or more specific account dimensions from a pull-down menu 1308, or specify individual measures (e.g., calculated and/or physical members) by way of a field 1310 of selectable actions and/or data. For example, if the user selects the radio button 1304, all dimensions flagged as “Account” that have an “Account type” attribute defined are located and provided within the pull-down menu 1308. An additional field 1312 can also be utilized to provide the user with assistance in selecting one of the radio buttons 1304 and 1306 and/or one of the selectable actions within the field 1310.

As a further example, if the radio button 1304 is selected and an account dimension is located and selected, then a determination can be made regarding whether there are any restrictions associated with the statements (e.g., formula) to be applied to the account dimension. If there is such a restriction, then the following exemplary MDX statements can be added around the formula for each time view that is associated with a restriction.
Iif(<Account dim name>. Currentmember.Properties(<Account type attribute name>) IS
<Mapped Applyto Restriction 1> OR <Account dim name>.Currentmember.Properties(<Account type attribute name>) IS <Mapped Applyto 2> OR <Account dim name>. Currentmember.Properties(<Account type attribute name>) IS <Mapped Applyto restriction 3> . . . , FORMULA, <New Time intelligence hierarchy name>. [<DefaultTimeViewCalculatedMemberName>])
In particular, the system of the subject invention can read restrictions from an XML “ApplyTo” tag list, and map system-defined account types with a user defined account type. A lookup table or the like can be employed to perform this mapping, and a mapped user account type can be inserted into the exemplary MDX statement as FORMULA.

In another example, if specific individual members are selected by the user from the field 1310 by way of the radio button 1306, then the system can exclude unselected members prior to applying a formula as illustrated with respect to FIG. 12. The following MDX statement is one exemplary manner by which to exclude unselected measures:
Iif(Measures. Currentmember IS <First excluded measure> OR Measures. Currentmember IS <Second excluded measure> OR Measures. Currentmember IS <Next excluded measure> OR . . . , <New Time intelligence hierarchy name>.[<DefaultTimeViewCalculatedMemberName>], FORMULA)
Upon making the appropriate selections, one or more aspects of the subject invention can be employed to generate new time-related views. For instance, a time hierarchy can be built, wherein the hierarchy includes members representing one of the views selected by the user in addition to a selected or appropriate hierarchy. Upon selecting one or more measures from the field 1310 (or selecting one or more dimensions that include at least one measure), one or more calculations selected and described with respect to FIG. 12 can be undertaken.

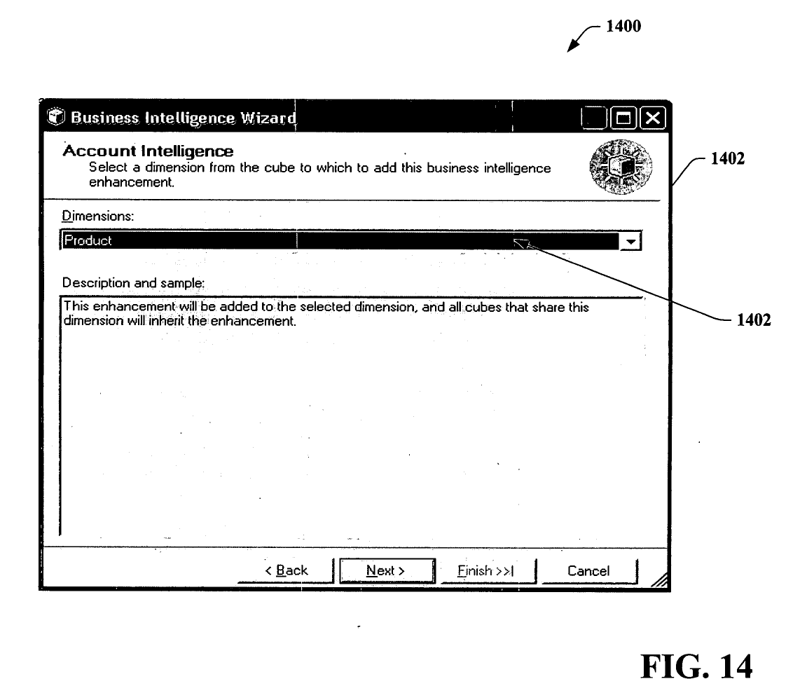

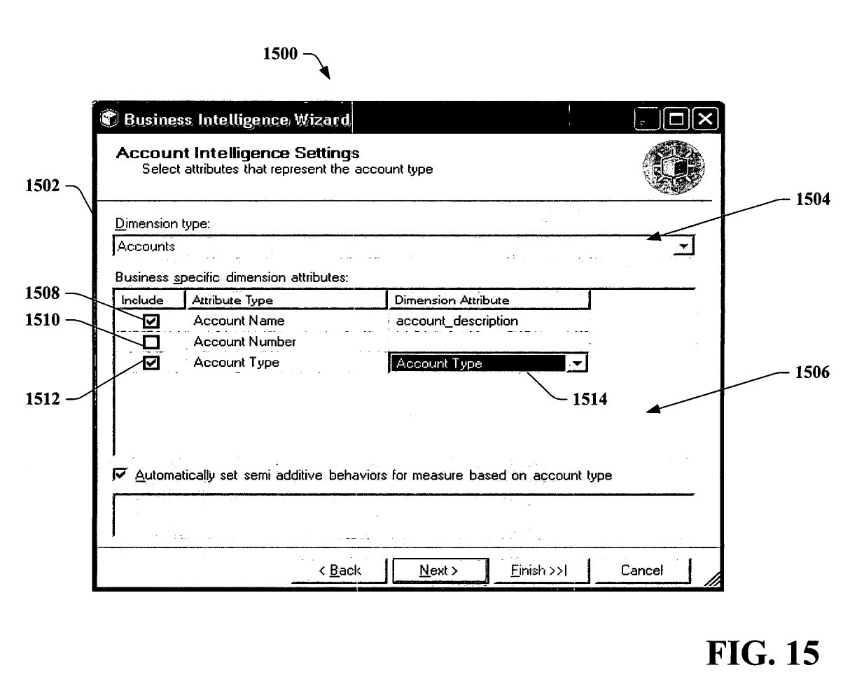

Now turning briefly to FIG. 14, a screenshot 1400 of an exemplary user interface 1402 is illustrated. Within the user interface 1402 a pull-down menu 1404 exists, wherein the user can select a dimension in which to add “Account Intelligence”. Thus, the pull-down menu 1404 can include a plurality of disparate dimensions that can be selected. Referring now to FIG. 15, a screenshot 1500 of an exemplary user interface 1502 is illustrated. The user interface 1502 includes a pull-down menu 1504 that enables a user to select a dimension type, as well as a field 1506 that includes a plurality of valid, disparate dimension attributes that can be selected. If a particular attribute type is selected (e.g., by way of selection boxes 1508-1512), then associated dimension attributes are provided to the user. Some attribute types can be associated with a plurality of dimension attributes—therefore, pull-down menus (such as a pull-down menu 1514) can be provided to the user to enable selection of a specific dimension attribute.

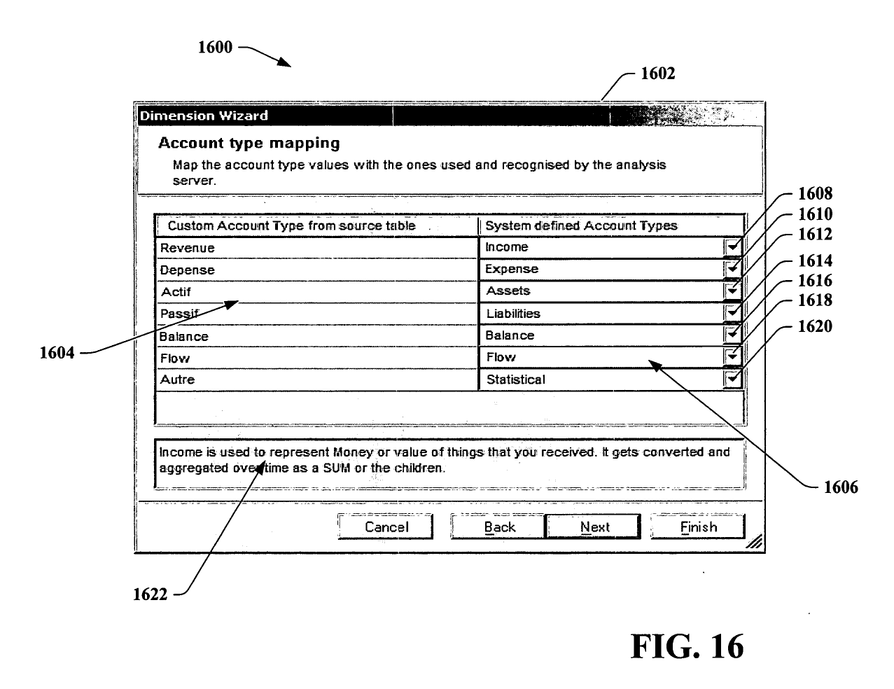

Turning now to FIG. 16, a screenshot 1600 of an exemplary user interface 1602 that can be utilized in connection with one or more aspects of the subject invention is illustrated. In accordance with one particular aspect of the subject invention, the user interface 1602 can only be provided to a user if particular attribute types and corresponding dimension attributes are selected (FIG. 15). The user interface 1602 can be beneficial in instances that a user codifies an attribute type differently than the attribute type is coded by a system. Thus, the user interface 1602 enables a user to map a user-defined account type to a system defined account type. For instance, this exemplary user interface 1602 includes a field 1604 of selectable account types and a field 1606 that includes a plurality of system defined account types. Various pull-down menus 1608-1620 can be provided to display disparate custom account types associated with specific system defined account types (as, in accordance with one aspect of the subject invention, several custom account types can be associated with a single system-defined account type). While the mapping can be accomplished by the user manually, it is contemplated that mapping can be done automatically through searching for common strings between the custom account types and the system defined account types. The user interface 1602 also includes a field 1622 that describes the system-defined accounts to assist the user in mapping account types.

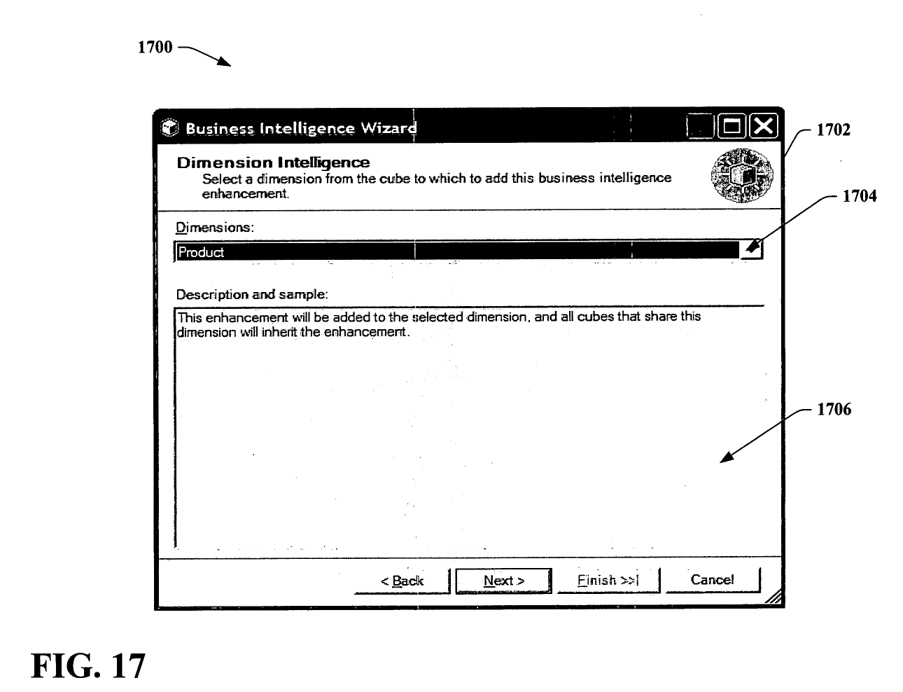

Now referring briefly to FIG. 17, a screenshot 1700 of an exemplary user interface 1702 that can be utilized in accordance with one or more aspects of the subject invention is illustrated. The user interface 1702 can be provided to the user, for example, after a user-selection of “Add Dimension Intelligence” from the user interface 1002 displayed in FIG. 10. The user interface 1702 includes a pull-down menu 1704 that enables the user to select a desired dimension within a multi-dimensional object (e.g., a cube). The user interface 1702 can also include a field 1706 that describes the action to be undertaken by the user.

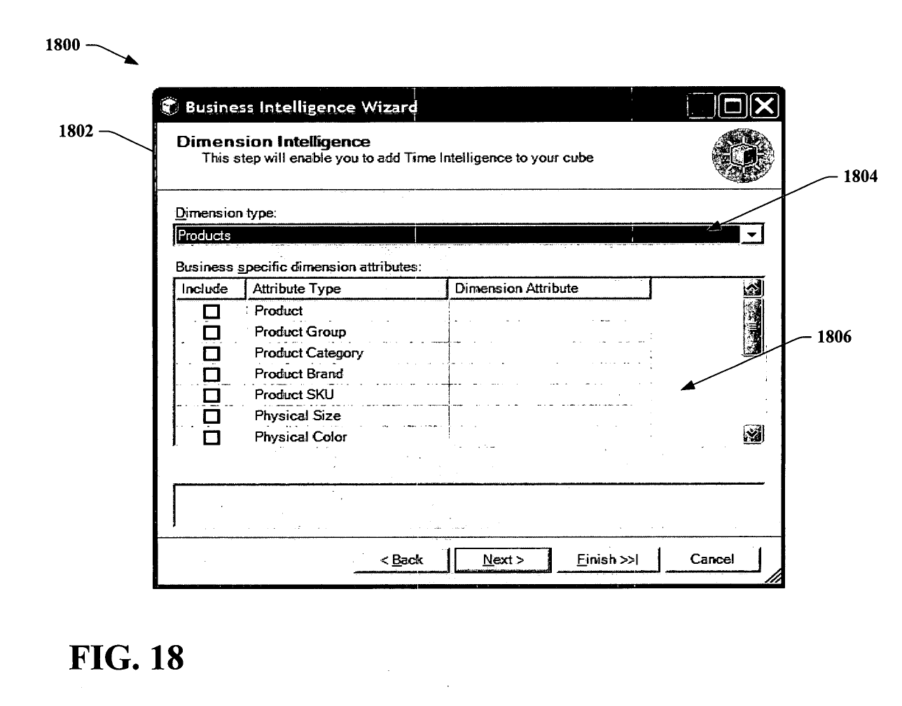

Turning now to FIG. 18, a screenshot 1800 of an exemplary user interface 1802 is illustrated, wherein the user interface 1802 can be presented to a user after selection of a dimension type in the user interface 1702 (FIG. 17). The user interface includes a pull-down menu 1804 that enables the user to select disparate dimension types (named in any suitable manner). For instance, a dimension can relate to time, a dimension can relate to geography, etc. Upon selection of the dimension type, attribute types associated with the selected dimension type are provided in a field 1806, wherein such attribute types can be selected by any suitable manner. Upon selection of one or more attribute types, dimension attributes associated with the attribute types can be displayed to the user. Thus, the user can be presented with a substantial amount of information relating to organization of a multi-dimensional object.

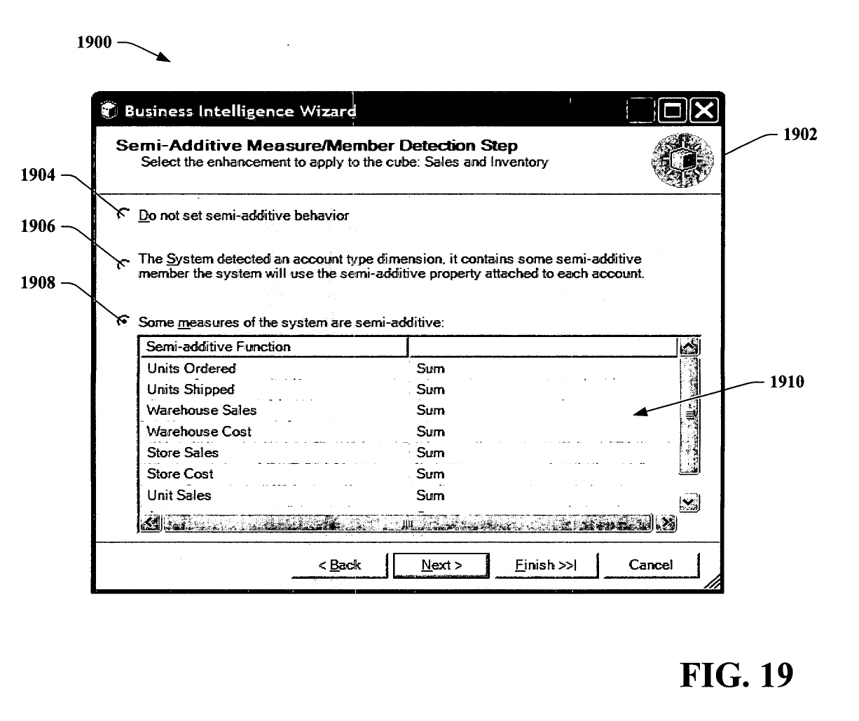

Referring now to FIG. 19, a screenshot 1900 of an exemplary user interface 1902 that can be provided subsequent to the user interface 1802 (FIG. 18) is illustrated. The user interface 1902 enables a multi-dimensional object, such as a data cube, to determine if some measure or member of the object should be labeled as semi-additive and/or how such measures or members are additive. A radio button 1904 can exist that informs the user interface 1902 that semi-additive behavior should not be set and/or utilized. A radio button 1906 can be selected as a default if it is determined that a certain attribute type exists that contains one or more semi-additive members. If the searched-for attribute type is not located (e.g., a dimension type and/or an attribute type), then a radio button 1908 can be selected by default. One or more selectable data and/or functions can be provided in a field 1910, and a user can select any combination of the data and/or functions and indicate the semi-additive behavior associated with the selections. A table of possible semi-additive selections is provided below.

| Semi-Additive Selection | Behavior |
|---|---|
| Not Additive | The value does not rollup at |
| | all along with a particular |
| | desired dimension (e.g., a time- |
| | related dimension). |
| Average of Children | The member value is evaluated |
| | as an average of its children |
| | with data along the time |
| | dimension. |
| First Child | The member of value is evaluated |
| | as the value of its first |
| | child along the time dimension. |
| Last Child | The member value is evaluated as |
| | the value of its last child |
| | along the time dimension. |
| Last Non-empty Child | The member value is evaluated as |
| | the value of its last child |
| | containing data along the time |
| | dimension. |
| First Non-empty child | The member value is evaluated |
| | as the value of its first child |
| | containing data along the time |
| | dimension |

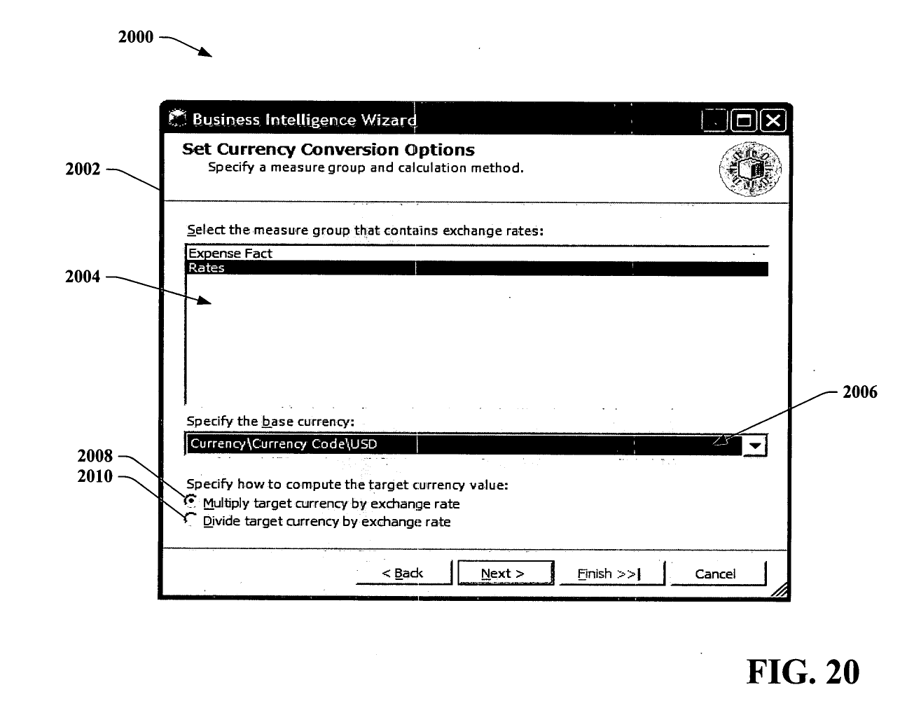

Turning now to FIG. 20, a screenshot 2000 of an exemplary user interface 2002 that can be utilized in accordance with the subject invention is illustrated. The user interface 2002 relates to enabling a user to customize an output associated with currency conversion. In particular, the user interface 2002 includes a field 2004 that comprises one or more measure groups that contain exchange rates. These measure groups can be automatically located by the system providing the user interface 2002 by determining measure groups within a multi-dimensional object (e.g., a cube) that have dimensions relating to currency. If no dimension relating to currency can be found within a measure group, then the user interface 2002 can provide the user with a warning indicating that an appropriate measure group cannot be found. The system can further search for a dimension associated with a type relating to time, and provide a warning if no such dimension is found. The user interface 2002 can further include a pull-down menu 2006 that enables the user to select a base currency from several currencies. Radio buttons 2008-2010 can also be provided to the user to enable such user to determine how to compute a target currency value.

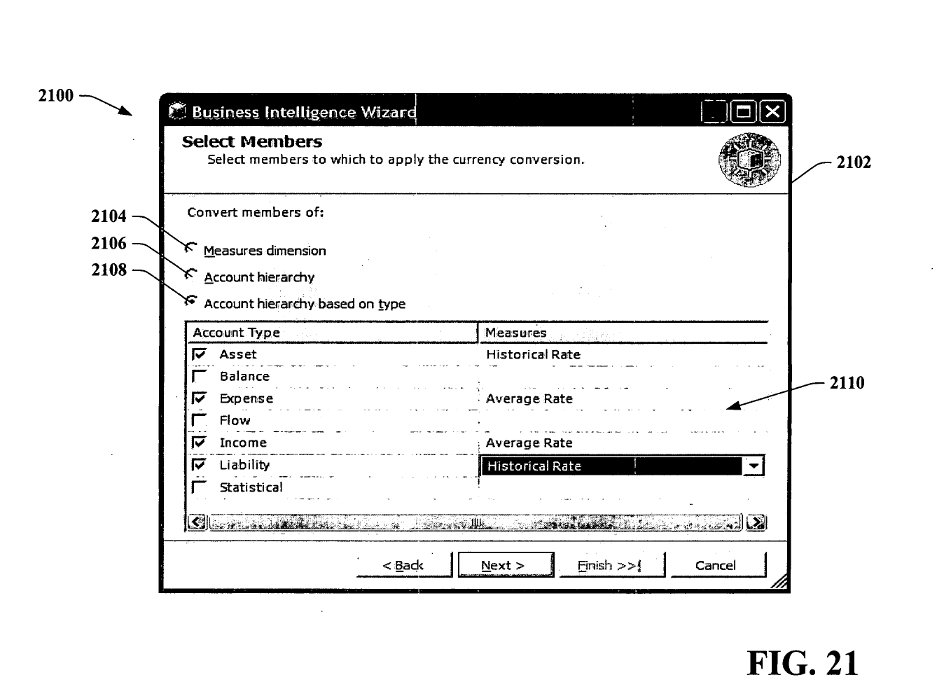

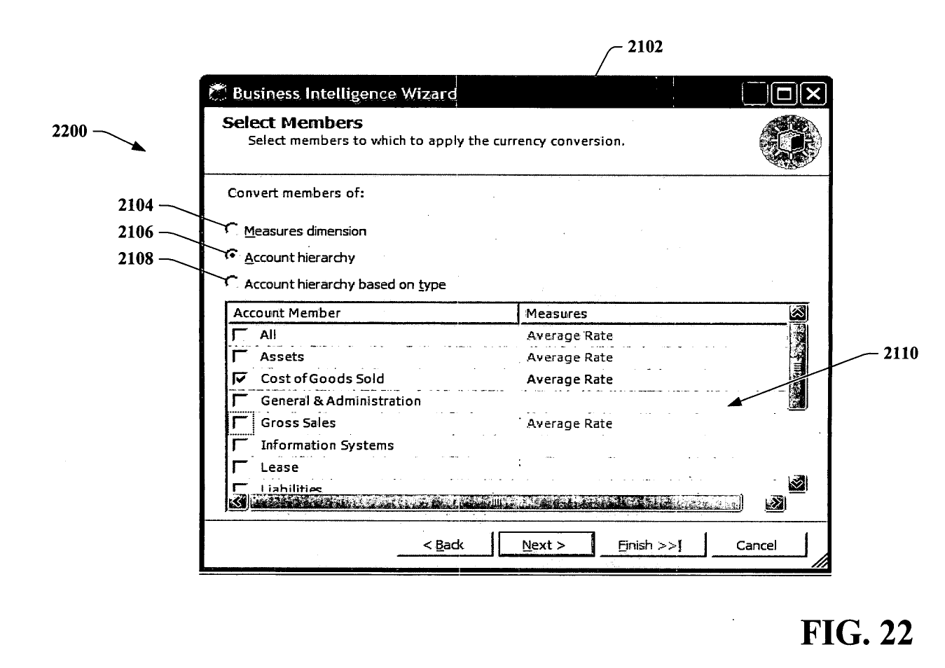

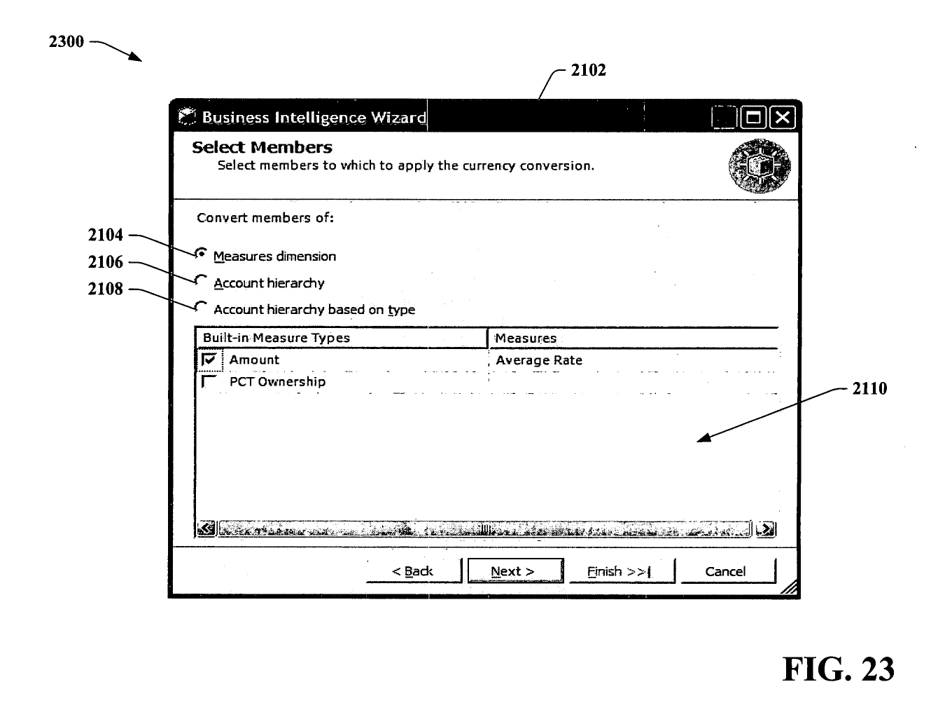

Turning now to FIG. 21, a screenshot 2100 of an exemplary user interface 2102 is illustrated. The user interface 2100 provides selectable actions/data that enable a user to select members in which a currency conversion is to be applied (specified previously). In particular, the user interface 2102 includes radio buttons 2104-2108 that enable the user to select one of a dimension, hierarchy, and/or hierarchy as a function of type. In this example, the radio button 2108 is selected, and a field 2110 displays a plurality of hierarchy types, wherein the types are selectable by a user. Upon selection of a type (e.g., through a check box), measures associated with the types are presented to a user. A conversion is applied to the types selected within the field 2110. FIG. 22 is a screenshot 2200 of the user interface 2102, wherein selectable entities within the field 2110 alter if the radio button 2106 is selected by a user. Similarly, FIG. 23 is a screenshot 2300 of the user interface 2102, wherein selectable entities within the field 2110 are altered if the radio button 2104 is selected by the user. Thus, when reviewing FIGS. 21-23 collectively, the user can specify dimensions and/or types to which a conversion is to be applied.

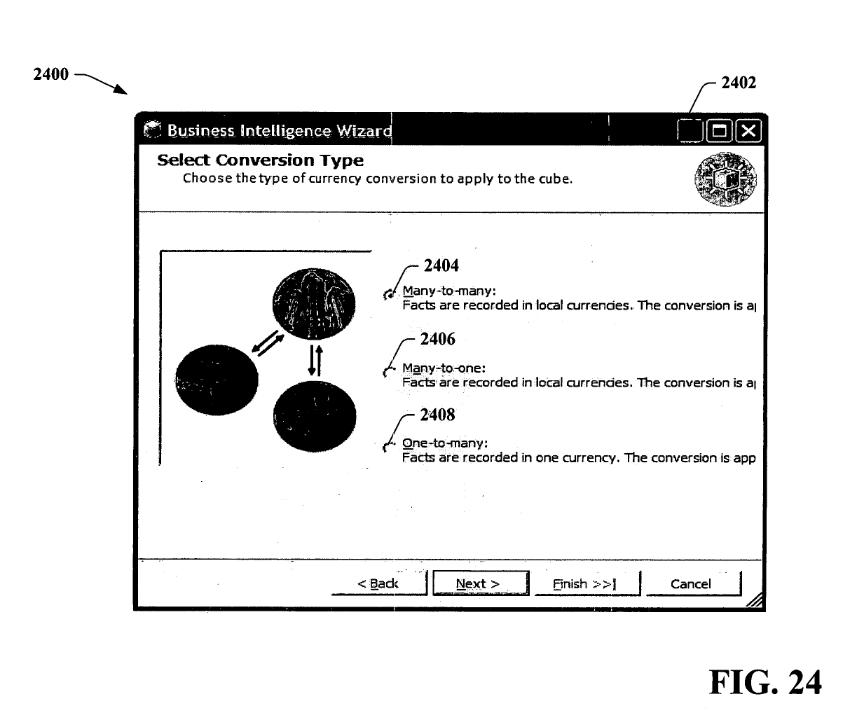

Now referring to FIG. 24, a screenshot 2400 of an exemplary user interface 2402 is illustrated. The user interface 2402 can be provided upon a user selecting members in which to apply a conversion, and includes radio buttons 2404-2408. In particular, the radio buttons 2404-2408 allow a user to specify how currencies are recorded and how they are to be converted to disparate currencies. For instance, a bank may be in possession of data that is associated with many currencies, and may wish to convert to several other disparate currencies. In another example, a bank can receive data relating to many currencies and convert that data into a single currency. The radio buttons 2404-2408 thus enable the user to further customize a currency conversion.

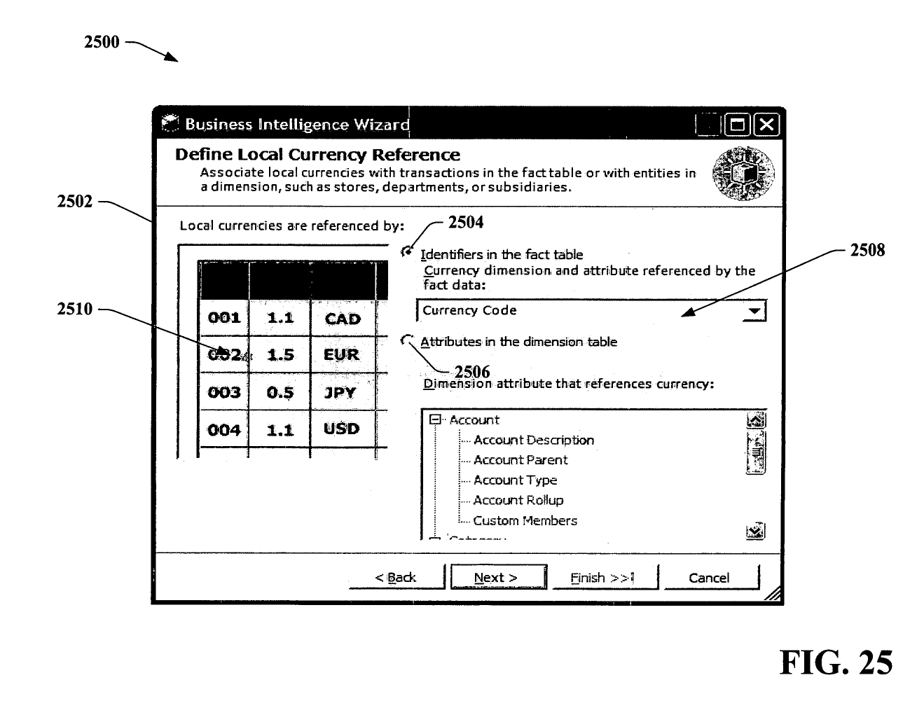

Now referring to FIG. 25, a screenshot 2500 of an exemplary user interface 2502 that can be provided to the user if either of the radio buttons 2406 and 2408 (FIG. 24) were selected previously. The user interface includes radio buttons 2504 and 2506, wherein the user and/or a computer-related entity can select either of such radio buttons 2504 and 2506. If the radio button 2504 is selected, a pull-down menu 2508 can be enabled that includes valid currency dimensions and attributes associated therewith, wherein the attributes are part of the dimensionality of the measure group of selected measures or attribute type (FIGS. 21-23). The user interface 2502 further includes a field 2510 that illustrates to a user a manner by which currencies are referenced. If measures were selected by way of radio button 2104 (FIGS. 21-23), then measure group dimensionality associated therewith is analyzed and every currency typed dimension is selected. For each of such dimensions, attributes whose members can be mapped to measure group attribute members that are associated with a rate of exchange are located. If the radio button 2106 (FIGS. 21-23) was selected and the radio button 2504 is subsequently selected, then dimensions that own the selected “account” is analyzed. Measure groups that reference such dimensions are located and their dimensionality is analyzed, which enables selection of every dimension associated with a desired type (e.g., currency typed dimensions). For each of such dimensions, attributes whose members can be mapped to measure group attribute members associated with currency exchange rate information are selected. If the radio button 2108 (FIGS. 21-23) is selected, and thereafter the radio button 2504 is subsequently selected, then dimensions that include an “account type” typed attribute are located. Thereafter, measure groups that reference such dimensions are located, and their dimensionality is analyzed, which enables selection of every dimension associated with a desired type (e.g., currency typed dimensions). For each of such dimensions, attributes whose members can be mapped to measure group attribute members associated with currency exchange rate information are selected.

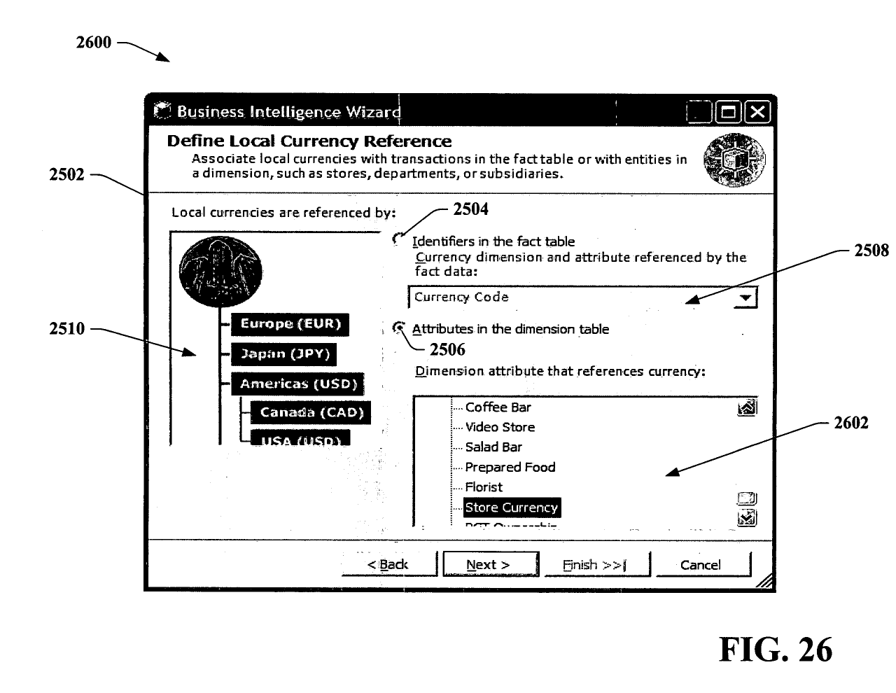

Now referring to FIG. 26, a screenshot 2600 of the user interface 2502 that illustrates a disparate aspect of the subject invention is provided. The screenshot 2600 illustrates the radio button 2506 as being selected, which activates an attribute treeview control field 2602. The field 2602 can include all available dimension/attributes bound to a selected measure group. Various warnings and/or errors can be presented to a user if there are problems associated with selected measures/members. For instance, if such measures/members are not dimensioned by a suitable dimension, then an error can be generated.

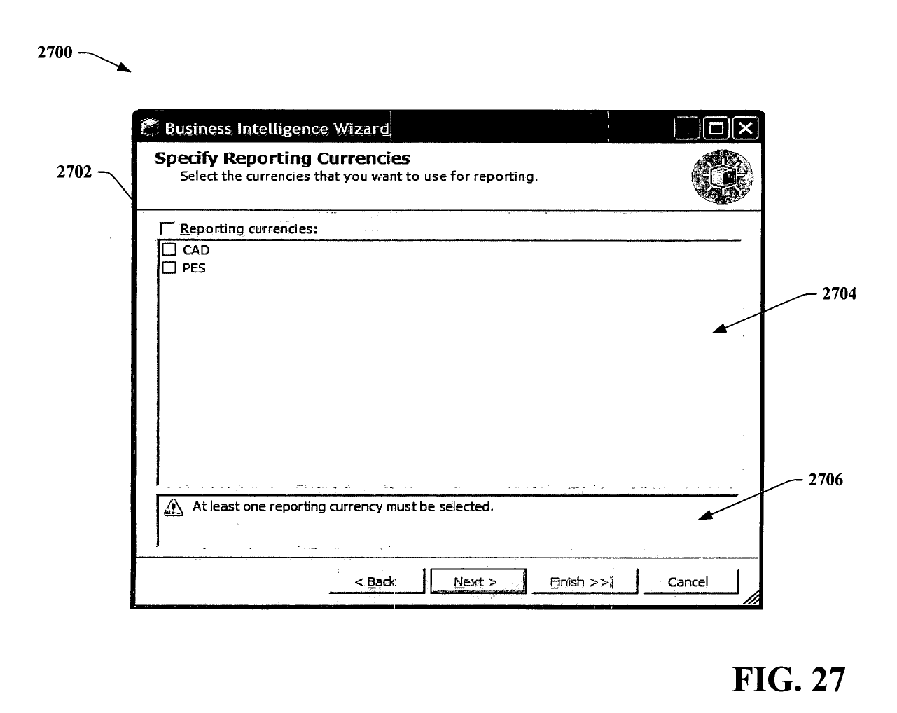

Now turning to FIG. 27, a screenshot 2700 of a user interface 2702 that can be utilized in accordance with one or more aspects of the subject invention is illustrated. The user interface 2702 includes a field 2704 that comprises one or more currencies that can be utilized as a reporting currency. The user interface 2702 further includes a field 2706 that provides a user with warnings/errors related to currency conversion.

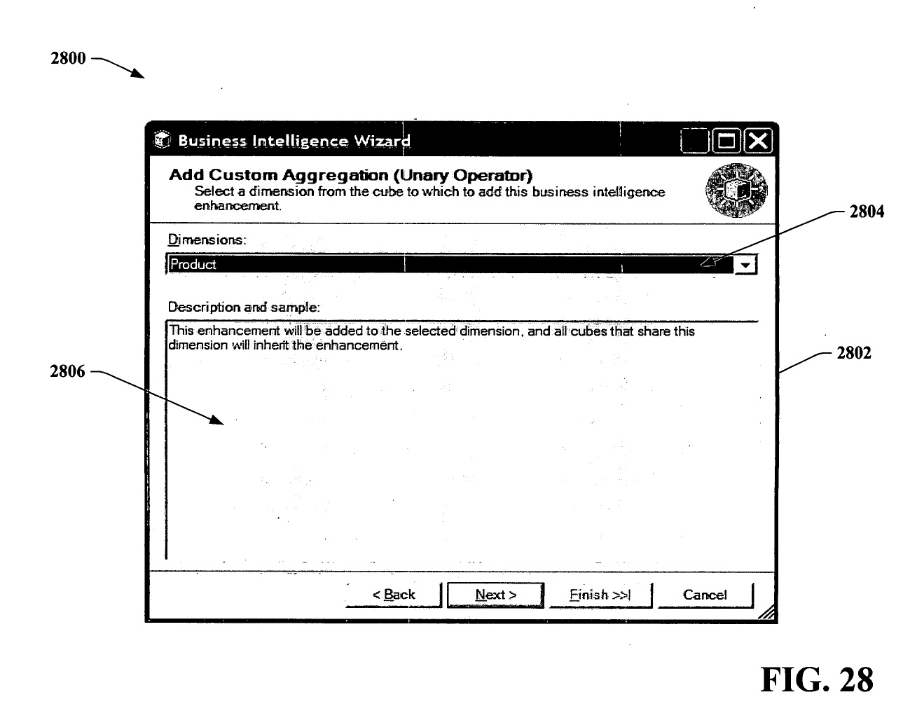

Referring now to FIG. 28, a screenshot 2800 of an exemplary user interface 2802 that is employable in accordance with an aspect of the subject invention is illustrated. The user interface 2802 enables a user to customize a manner in which data is “rolled up” along selected dimensions. For example, the user can specify a single dimension at a time, as well as alter a default dimension calculation order. The user interface 2802 includes a pull-down menu 2804 that comprises a listing of available dimensions, wherein the user can select one or more of such dimensions. The user interface 2802 further includes a field 2806 that describes a selected action and/or provides the user with a warning relating to the selected action. In accordance with one aspect of the subject invention, the selected dimension should be associated with a parent attribute (otherwise a warning can be displayed).

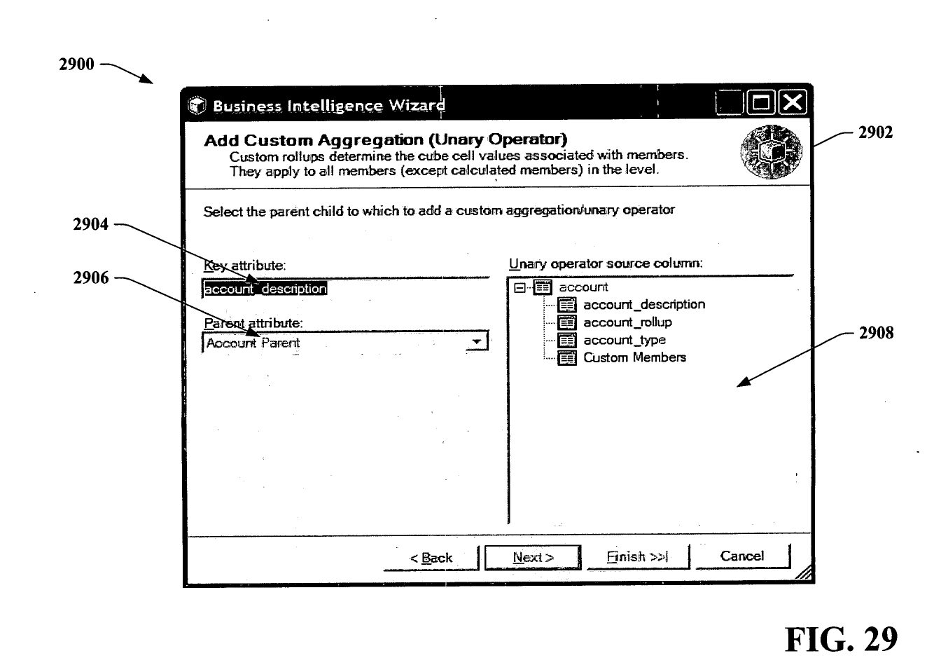

Turning now to FIG. 29, a screenshot 2900 of a user interface 2902 that can be utilized in connection with the subject invention is illustrated. In the user interface 2902, the user has an ability to select a child-parent relationship in which to apply a unary operator column. The user interface 2902 includes a field 2904 that displays a key attribute of a dimension selected within the user interface 2802 (FIG. 28). A pull-down menu 2906 is also provided to enable a user to select attributes that include tags indicating that such attributes are parent attributes. A field 2908 includes a drop-down list that comprises string columns to which the selected dimension is bound. In accordance with one particular aspect of the subject invention, more than one table can be within the field 2908.

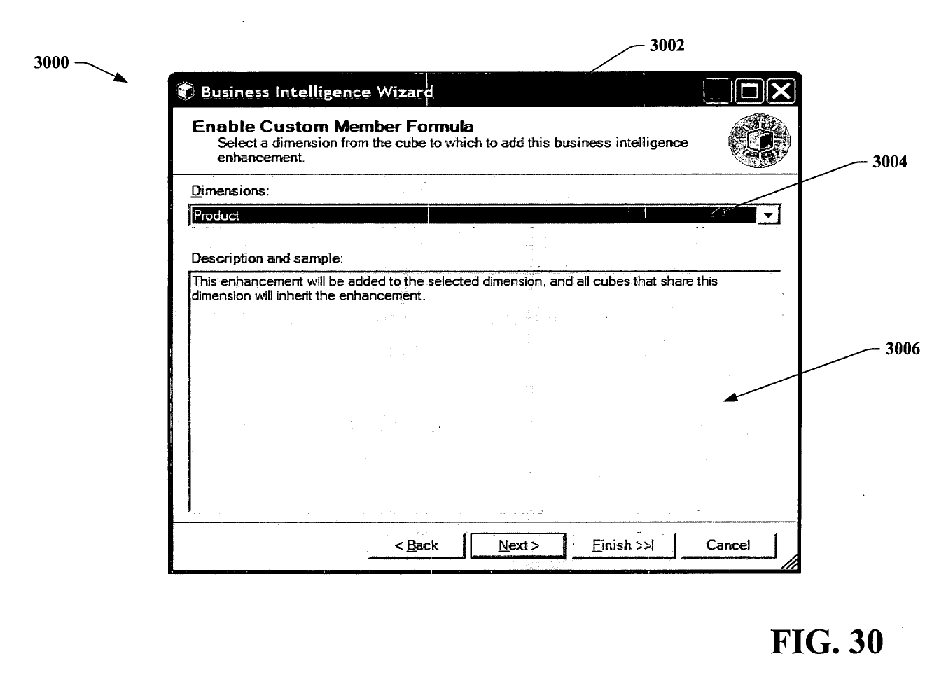

Referring to FIG. 30, a screenshot 3000 of an exemplary user interface 3002 that can be employed in association with one or more aspects of the subject invention is illustrated. The user interface 3002 facilitates enabling a user to customize a manner in which a member of a multi-dimensional object is to be evaluated and computed. The user can specify the aforementioned customization for one dimension at a time and/or multiple dimensions at a time. Furthermore, the user interface 3002 can assist the user in altering a default dimension calculation order. The user interface 3002 includes a pull-down menu 3004 that allows a user to select a dimension for which a custom member formula is to be customized. The user interface 3002 further includes a field 3006 that can provide the user with information, instructions, and or warnings relating to the user's selection.

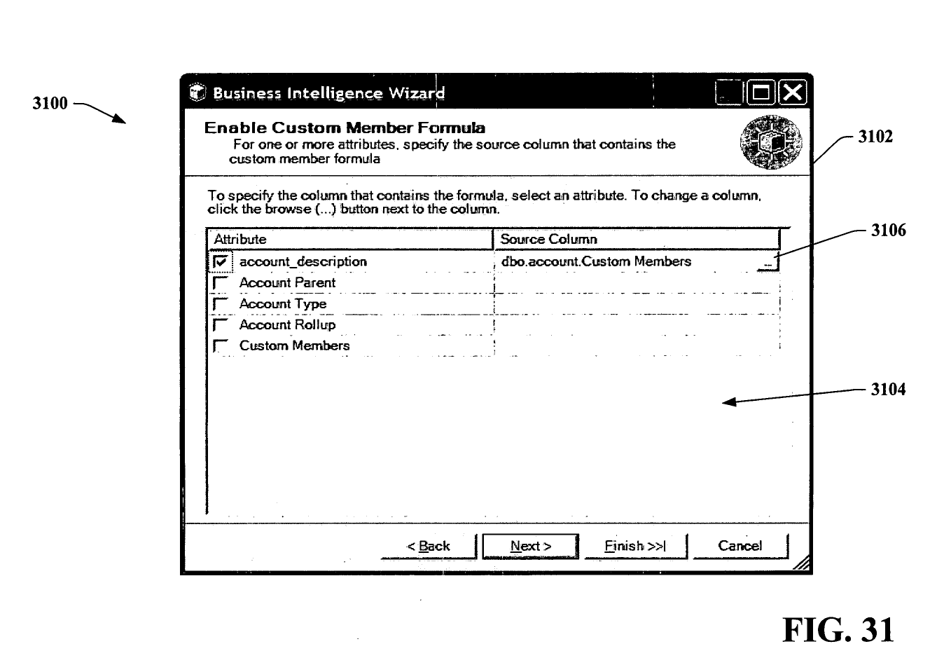

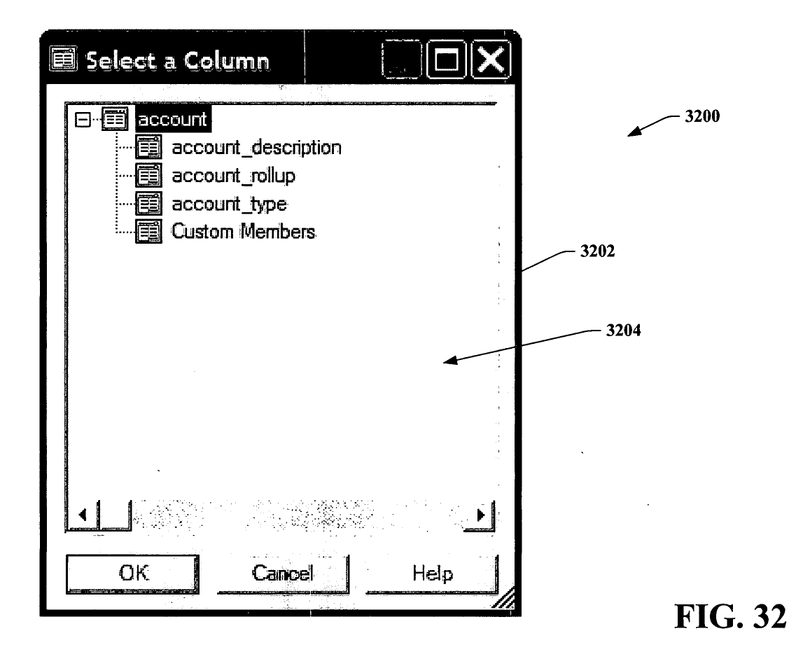

Turning now to FIG. 31, a screenshot 3100 of a user interface 3102 that can be provided subsequent to the user interface 3002 (FIG. 30) is illustrated. The user interface 3102 includes a field 3104 wherein a user can select one or more attributes from a list of attributes that are associated with the dimension selected within the user interface 3002. The user selects the attribute for which a custom member formula column should be associated. For instance, the user can select the “account_description” attribute, and a source column associated with such attribute can be presented. To alter the source column, the user can select a button 3106 that enables a plurality of columns associated with the selected attribute to be presented to the user, wherein such user can choose a desired source column that contains the desired formula (algorithm, statements, . . . ). Referring briefly to FIG. 32, a screenshot 3200 of an exemplary user interface 3202 that can be activated upon selection of the button 3106 (FIG. 31) is illustrated. The user interface 3202 includes a field 3204 that displays a plurality of selectable columns that are bound to a previously selected attribute.

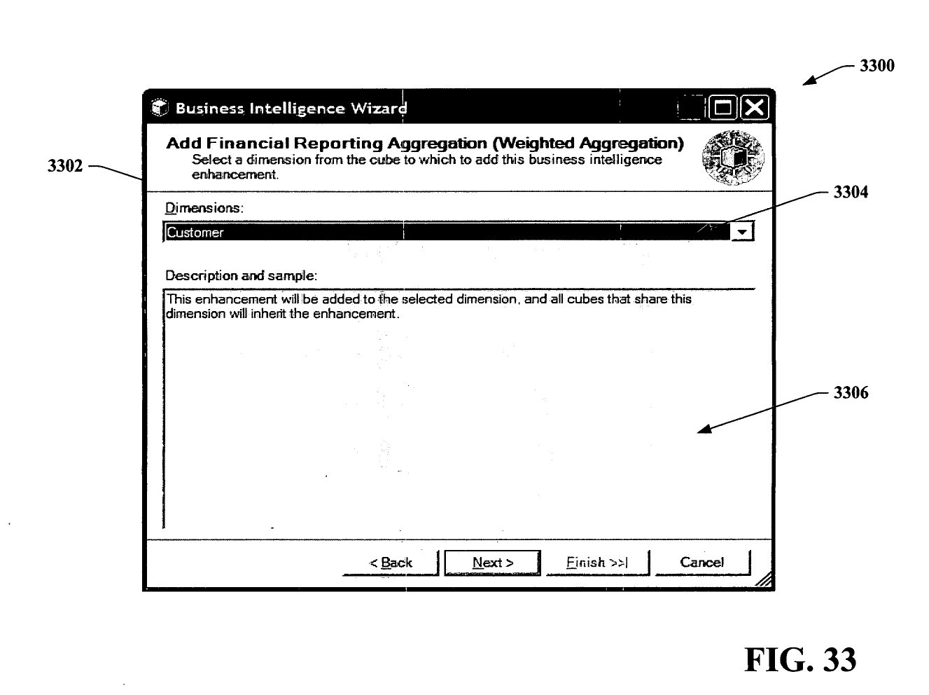

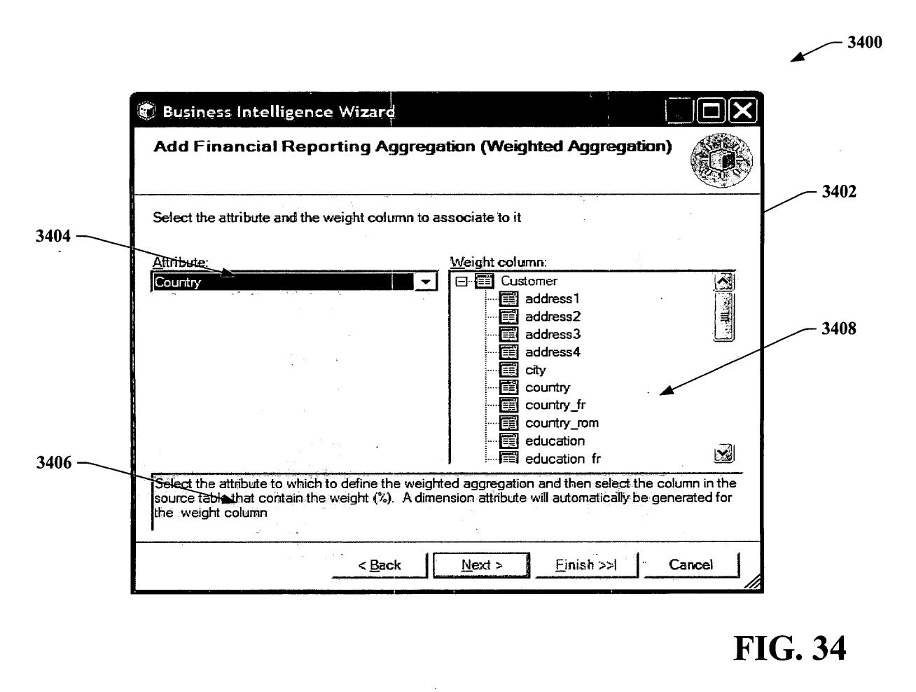

Now turning to FIG. 33, a screenshot 3300 of an exemplary user interface 3302 that enables a user to customize a manner in which data is “rolled up” along a parent-child hierarchy within a dimension is illustrated. The user interface 3302 includes a pull-down menu 3304 that provides a user with a mechanism for selecting a dimension in which to add financial reporting aggregation. Financial reporting aggregation is a common business scenario within budgeting and other financial contexts wherein a member doesn't roll-up 100% of its value to its parent. The user interface 3302 further includes a field 3306 that provides the user with information, instructions, and/or warnings relating to the exemplary feature provided by the user interface 3302. Referring now to FIG. 34, a screenshot 3400 of a user interface 3402 that can be presented to the user subsequent to such user selecting a dimension from the pull-down menu 3304 (FIG. 33) is illustrated. The user interface 3402 includes a pull-down menu 3404 wherein the user can select a parent attribute associated with the previously selected dimension. If the dimension is not related to a parent attribute, then a warning can be presented in a field 3406 within the user interface 3402. Another field 3408 can be presented to the user, wherein the field 3408 includes columns within a source table that contain a desired weight. The user interface 3402 can facilitate automatic generation of a dimension attribute associated with the selected column.

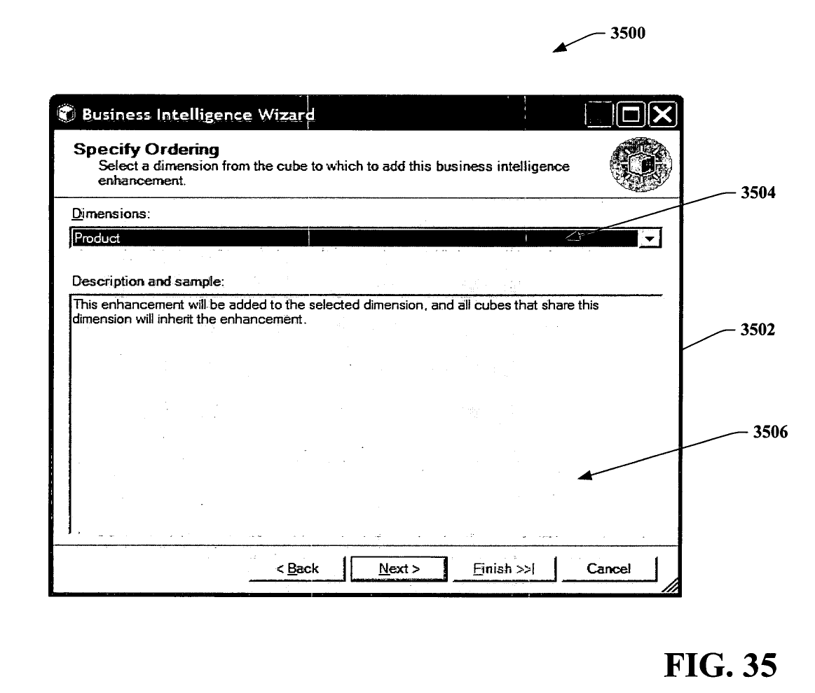

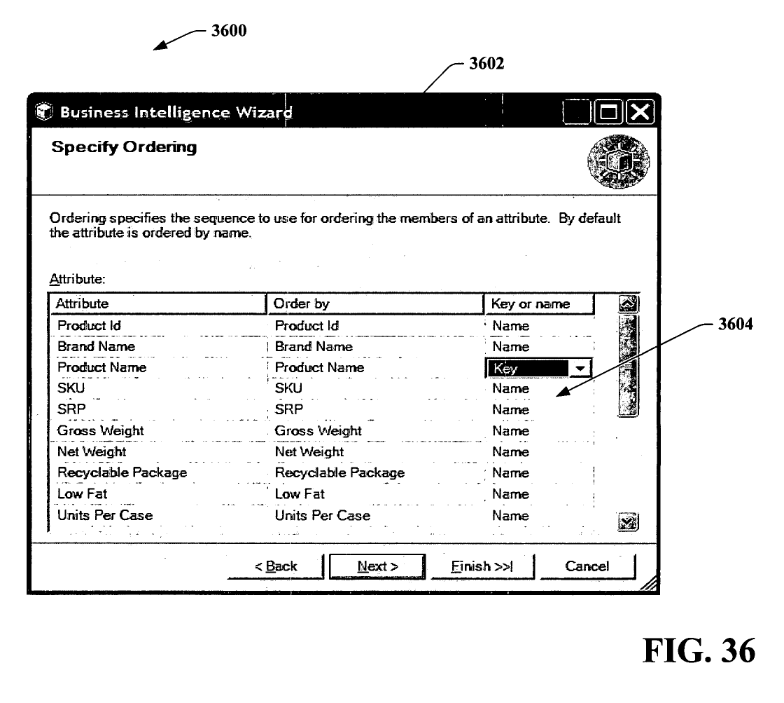

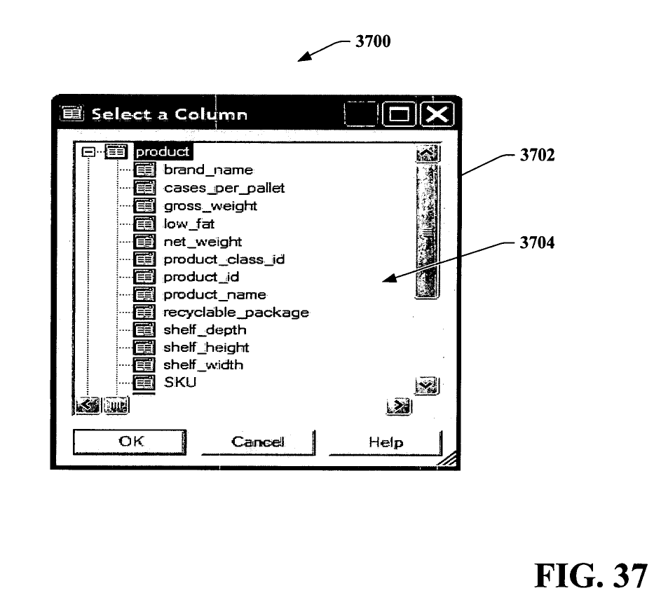

Turning now to FIG. 35, a screenshot 3500 of an exemplary user interface 3502 that can be utilized in connection with one or more aspects of the subject invention is illustrated. The user interface 3502 facilitates user-customization of a way in which members are to be sorted. In accordance with one aspect of the subject invention, the sorting can be applied by attribute (rather than by level). The user interface 3502 includes a pull-down menu 3504 that provides a user with a mechanism to select a dimension (e.g., within a cube or cubes) whose members are desirably sorted in a customized way. A field 3506 is also provided within the user interface 3502 to provide information, instructions, and/or warnings to the user. FIG. 36 is a screenshot 3600 of a user interface 3602 that is provided to the user subsequent to the user selecting a dimension from the pull-down menu 3504 (FIG. 35). The user interface 3602 includes a field 3604 that displays a list of attributes available for the previously selected dimension, as well as attributes by which members of the dimension can be sorted. For instance, the user can order any attribute by any other attribute (including itself). In accordance with one aspect of the subject invention, from the user interface 3602 the user can indicate that a new attribute is desirably created. Turning briefly to FIG. 37, a screenshot 3700 of a user interface 3702 that is provided to the user if such user desires to create a new attribute is illustrated. A field 3704 includes a listing of selectable columns associated with a previously chosen dimension. If the user selects the column, a new attribute can be created with such selected column.

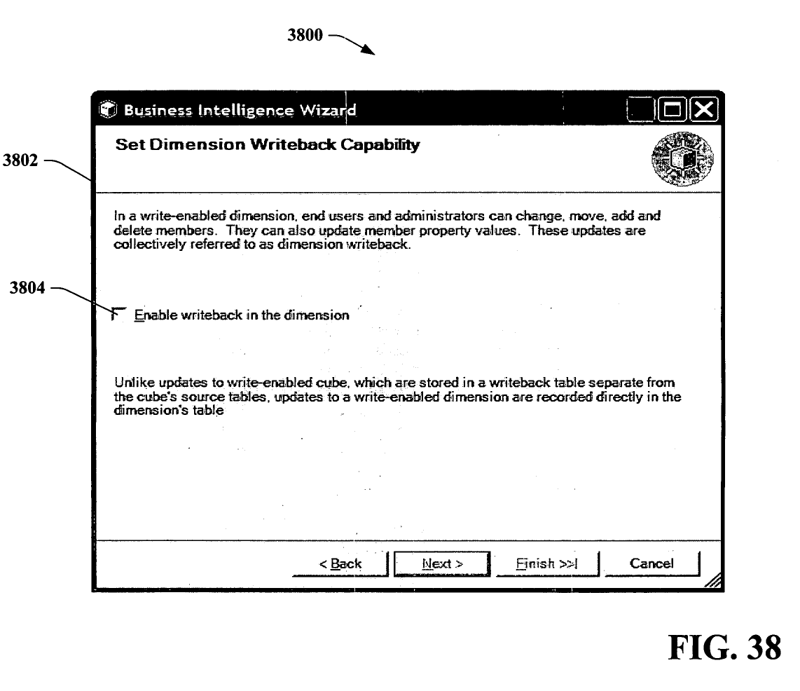

Now referring to FIG. 38, a screenshot 3800 of an exemplary user interface 3802 that can be utilized in connection with one or more aspects of the subject invention is illustrated. The user interface 3802 includes a checkbox 3804, that when selected enables a user to specify dimension content that can be manipulated (rename members, add members, remove members, change member properties, . . . ) for a particular selected dimension.

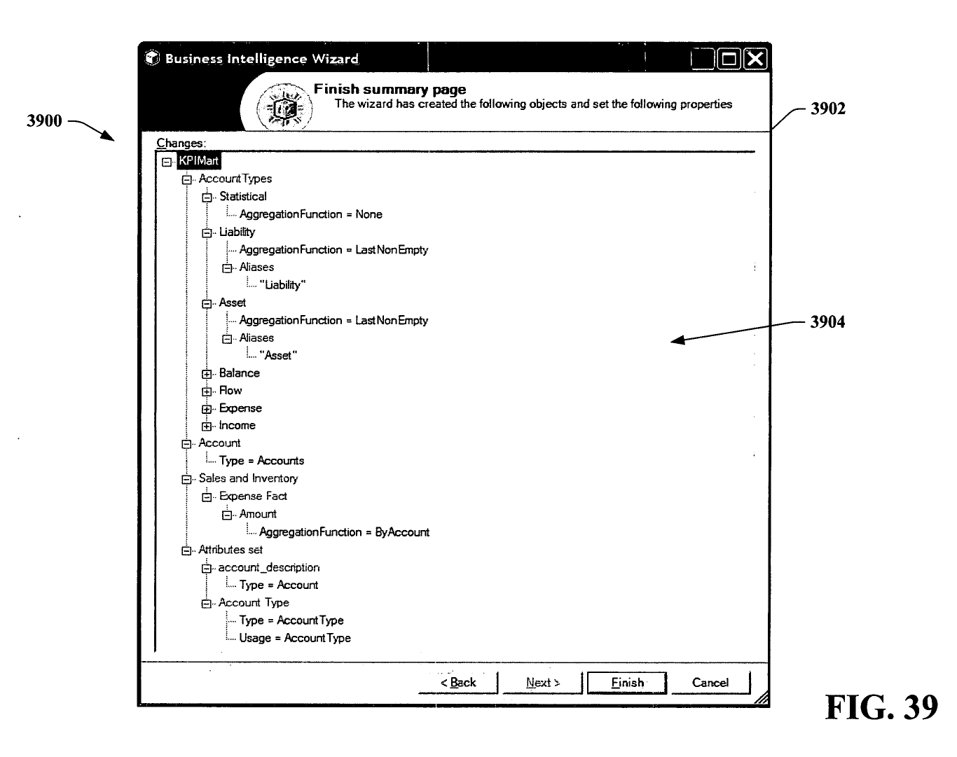

Turning to FIG. 39, a screenshot 3900 of a user interface 3902 that can summarize to a user the actions undertaken by way of the previously described user interfaces is illustrated. The user interface 3902 can further inform the user that settings displayed in a field 3904 can be manipulated from disparate panels, by navigating through the user interfaces at a later time, and the like. The user interface 3902 can categorize the displayed summary by objects and display such objects in a tree format. Moreover, properties altered can be categorized by dimension, wherein under each dimension a list of modified attributes and new values associated therewith can be presented to the user.

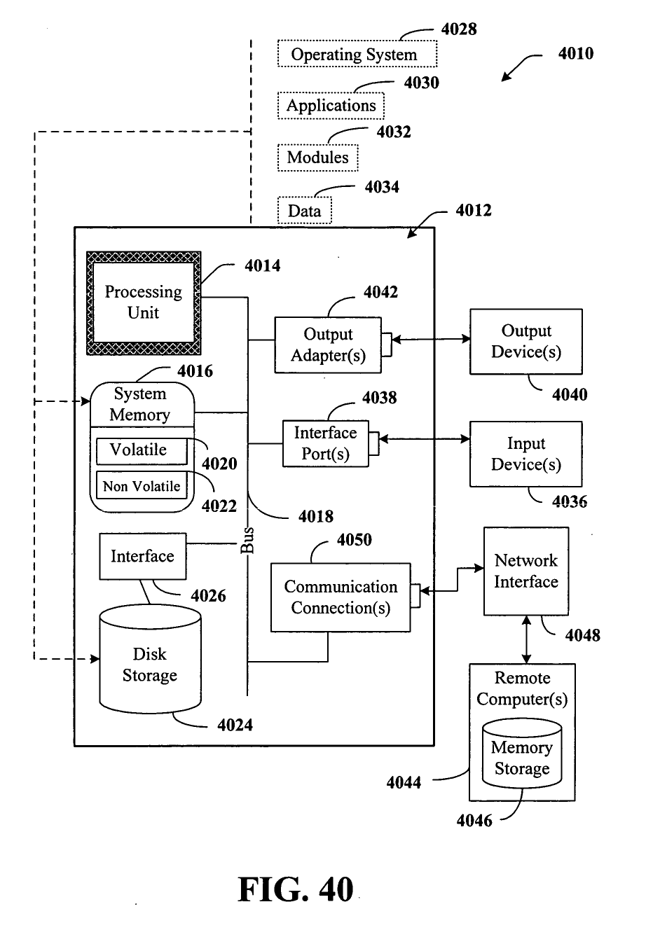

In order to provide additional context for various aspects of the subject invention, FIG. 40 and the following discussion are intended to provide a brief, general description of a suitable operating environment 4010 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 4010 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 40, an exemplary environment 4010 for implementing various aspects of the invention includes a computer 4012. The computer 4012 includes a processing unit 4014, a system memory 4016, and a system bus 4018. The system bus 4018 couples system components including, but not limited to, the system memory 4016 to the processing unit 4014. The processing unit 4014 can be any of various available processors. Dual microprocessors and other multiprocessor architectures also can be employed as the processing unit 4014.

The system bus 4018 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 4016 includes volatile memory 4020 and nonvolatile memory 4022. The basic input/output system (BIOS), containing the basic routines to transfer information between elements within the computer 4012, such as during start-up, is stored in nonvolatile memory 4022. By way of illustration, and not limitation, nonvolatile memory 4022 can include read only memory (ROM), programmable ROM (PROM), electrically programmable ROM (EPROM), electrically erasable ROM (EEPROM), or flash memory. Volatile memory 4020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 4012 also includes removable/nonremovable, volatile/nonvolatile computer storage media. FIG. 40 illustrates, for example a disk storage 4024. Disk storage 4024 includes, but is not limited to, devices like a magnetic disk drive, floppy disk drive, tape drive, Jaz drive, Zip drive, LS-100 drive, flash memory card, or memory stick. In addition, disk storage 4024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 4024 to the system bus 4018, a removable or non-removable interface is typically used such as interface 4026.

It is to be appreciated that FIG. 40 describes software that acts as an intermediary between users and the basic computer resources described in suitable operating environment 4010. Such software includes an operating system 4028. Operating system 4028, which can be stored on disk storage 4024, acts to control and allocate resources of the computer system 4012. System applications 4030 take advantage of the management of resources by operating system 4028 through program modules 4032 and program data 4034 stored either in system memory 4016 or on disk storage 4024. It is to be appreciated that the subject invention can be implemented with various operating systems or combinations of operating systems.

A user enters commands or information into the computer 4012 through input device(s) 4036. Input devices 4036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 4014 through the system bus 4018 via interface port(s) 4038. Interface port(s) 4038 include, for example, a serial port, a parallel port, a game port, and a universal serial bus (USB). Output device(s) 4040 use some of the same type of ports as input device(s) 4036. Thus, for example, a USB port may be used to provide input to computer 4012, and to output information from computer 4012 to an output device 4040. Output adapter 4042 is provided to illustrate that there are some output devices 4040 like monitors, speakers, and printers among other output devices 4040 that require special adapters. The output adapters 4042 include, by way of illustration and not limitation, video and sound cards that provide a means of connection between the output device 4040 and the system bus 4018. It should be noted that other devices and/or systems of devices provide both input and output capabilities such as remote computer(s) 4044.

Computer 4012 can operate in a networked environment using logical connections to one or more remote computers, such as remote computer(s) 4044. The remote computer(s) 4044 can be a personal computer, a server, a router, a network PC, a workstation, a microprocessor based appliance, a peer device or other common network node and the like, and typically includes many or all of the elements described relative to computer 4012. For purposes of brevity, only a memory storage device 4046 is illustrated with remote computer(s) 4044. Remote computer(s) 4044 is logically connected to computer 4012 through a network interface 4048 and then physically connected via communication connection 4050. Network interface 4048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 4050 refers to the hardware/software employed to connect the network interface 4048 to the bus 4018. While communication connection 4050 is shown for illustrative clarity inside computer 4012, it can also be external to computer 4012. The hardware/software necessary for connection to the network interface 4048 includes, for exemplary purposes only, internal and external technologies such as, modems including regular telephone grade modems, cable modems and DSL modems, ISDN adapters, and Ethernet cards.

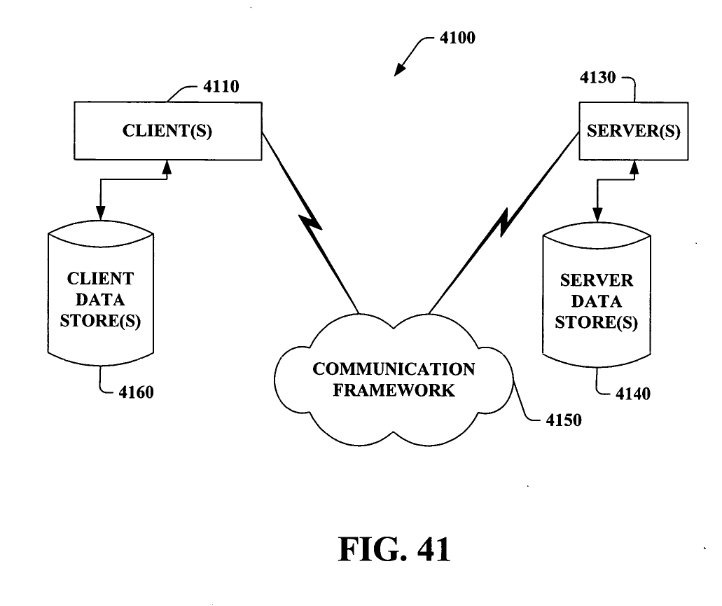

FIG. 41 is a schematic block diagram of a sample-computing environment 4100 with which the subject invention can interact. The system 4100 includes one or more client(s) 4110. The client(s) 4110 can be hardware and/or software (e.g., threads, processes, computing devices). The system 4100 also includes one or more server(s) 4130. The server(s) 4130 can also be hardware and/or software (e.g., threads, processes, computing devices). The servers 4130 can house threads to perform transformations by employing the subject invention, for example. One possible communication between a client 4110 and a server 4130 can be in the form of a data packet adapted to be transmitted between two or more computer processes. The system 4100 includes a communication framework 4150 that can be employed to facilitate communications between the client(s) 4110 and the server(s) 4130. The client(s) 4110 are operably connected to one or more client data store(s) 4160 that can be employed to store information local to the client(s) 4110. Similarly, the server(s) 4130 are operably connected to one or more server data store(s) 4140 that can be employed to store information local to the servers 4130.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates automatically producing an output relating to a multi-dimensional data object, comprising:
an interface component that receives responses to one or more questions and produces commands that are a function of the responses; and
an execution engine that executes the commands and manipulates the multi-dimensional data object in accordance with the responses.

2. The system of claim 1, the multi-dimensional object relates to one or more of a data cube, a dimension, a data source, an attribute, a property, a member, and a mining model.

3. The system of claim 1, the questions relate to one or more of currency conversion, manipulation of time data, accounting, and financial aggregation.

4. The system of claim 1, further comprising a manipulation component that receives the manipulated multi-dimensional object and applies algorithms thereto to generate an output that corresponds to a user intention as represented by way of the responses.

5. The system of claim 1, further comprising a question generating component that automatically selects the one or more questions from a list of questions and presents the one or more questions to a user.

6. The system of claim 5, further comprising a context recognition component that recognizes a user perspective of the multi-dimensional object at a time of initiating the system, the one or more questions selected as a function of the user perspective.

7. The system of claim 5, further comprising an updating component that updates the list of questions.

8. The system of claim 7, the updating component removes one or more questions from the list after a command has been executed as a function of the one or more questions.

9. The system of claim 5, a question automatically selected is more granular than a question that was previously answered.

10. The system of claim 1, the execution engine facilitates storing the commands for subsequent use.

11. A method for semi-automatically updating a multi-dimensional object, comprising:
receiving a plurality of responses corresponding to a plurality of questions;
generating commands to update the multi-dimensional object as a function of the plurality of responses; and
executing the commands against the multi-dimensional object.

12. The method of claim 11, further comprising applying one or more algorithms to the updated multi-dimensional object to generate an output in accordance with the responses.

13. The method of claim 12, the output relates to one or more of currency conversion, accounting, and time-data updating.

14. The method of claim 12, further comprising:
storing the generated commands and the one or more applied algorithms; and
packaging the commands with the algorithms to enable later utilization thereof.

15. The method of claim 11, further comprising presenting the plurality of questions to a user, the plurality of questions selected from a list of questions.

16. The method of claim 15, further comprising determining which questions to present to the user as a function of the perspective of the user with respect to the multi-dimensional object.

17. The method of claim 11, the multi-dimensional object relates to one or more of a data cube, a dimension, an attribute, a column, a property, and a data source.

18. A system that facilitates semi-automatically updating a multi-dimensional object, comprising:
means for receiving responses to one or more questions and generating commands to alter the multi-dimensional object as a function of the responses; and
means for executing the commands against the multi-dimensional object.

19. The system of claim 18, further comprising means for selecting the one or more questions from a list of questions.

20. The system of claim 19, further comprising means for presenting the questions to a user.
